(19) United States
(12) Patent Application Publication
(10) Pub. No.: US 2026/0352440 A1
(43) Pub. Date: Nov. 5, 2026

(54) PROCESSING UNIT FOR ENCRYPTED DATA

(71) Applicant: HECUSYS LLC, ATLANTA, GA (US)

(72) Inventor: PETER BREUER, MADRID (ES)

(73) Assignee: HECUSYS LLC, ATLANTA, GA (US)

(21) Appl. No.: 19/467,255

(22) Filed: Feb. 2, 2026

Related U.S. Application Data
(63) Continuation-in-part of application No. 18/896,885, filed on Sep. 25, 2024.
(60) Provisional application No. 63/585,382, filed on Sep. 26, 2023.

(51) Int. Cl. H04L 9/06; G06F 9/30

(52) U.S. Cl. CPC H04L 9/0618; G06F 9/30181

(57) ABSTRACT

A processor is provided. The processor includes a pipeline comprising a plurality of processing stages including a fetch stage. The processor includes an instruction memory management unit (iMMU) configured to translate instruction addresses for accessing instruction memory and a dynamic translation unit (DTU) disposed between the iMMU and the fetch stage, and a plurality of encrypted processing stages arranged within the pipeline, wherein the DTU is configured to receive instruction words from the iMMU and selectively translate at least some of the instruction words before providing instruction words to the fetch stage, and wherein encrypted data processed by the plurality of encrypted processing stages remains encrypted throughout propagation through the pipeline.

### CROSS-REFERENCE TO RELATED APPLICATIONS

This application claims benefit of priority from U.S. patent application Ser. No. 18/896,885, filed Sep. 25, 2024, which claims benefit of priority to U.S. Provisional Application No. 63/585,382, filed Sep. 26, 2023, both of which is hereby incorporated by reference in their entirety.

### BACKGROUND

The embodiments describe a processor that works encrypted, i.e., operates on encrypted data wherein the unencrypted data is never exposed. As far as the privileged observer (a program running in supervisor mode) can tell, the user data in registers and memory of the processing device are in encrypted form. In the embodiments, that observer sees only encrypted values hiding uniformly and independently distributed user data with no statistical bias and differing systematically at each point in time and register and memory cell from the same program compiled for and running unencrypted on a standard platform. The scheme of differences is determined by the program compiler and is not known to the processor.

Data encryption is often used to protect sensitive information by transforming data using an encryption key to make the data unreadable without a corresponding decryption key. In a typical distributed computing arrangement, data stored on a first computer that it is desirable to process using the processing power of other computers is encrypted before it is transferred to the other computers. The other computers are arranged such that they decrypt the data and process the data to generate further data, before encrypting the further data and transferring the encrypted further data to the first computer. While such an arrangement allows data to be transferred between computers securely, the data is vulnerable to privileged administrators when it is decrypted at the computers carrying out the distributed processing. It is within this context that the embodiments arise.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a Dynamic Translation Unit (DTU) positioned on the instruction memory path between the input to the pipeline's fetch stage and the instruction memory management unit (iMMU) in the encrypted processor.

FIG. 2 illustrates further details of the dynamic translation unit in accordance with some embodiments.

FIG. 3 illustrates further details of a subunit of the DTU in accordance with some embodiments.

FIG. 4 illustrates a subunit sharing storage in accordance with some embodiments.

FIG. 5 provides a summary of the encrypted processor's RISCV instructions in accordance with some embodiments.

FIG. 6 illustrates an embodiment of a dynamic translation unit (DTU) positioned within an instruction processing pipeline of a processor operating on encrypted data.

### DETAILED DESCRIPTION

Described herein, in various embodiments, is a processor that operates on encrypted data without exposing unencrypted data during the processing to memory, I/O, or any peripheral external to the processor pipeline. The embodiments provide for security in conjunction with (1) a special Complex Instruction Set Computer (CISC) machine code instruction set that runs on embodiments and is described herein, and 2) a ‘chaotic’ machine code compiler, as well as 3) a processing provided by the embodiments. It should be appreciated that encryption serves to mix entropy generated by the compiler into the runtime traces of programs running on the embodiments. That entropy is sufficient that any indicative biases that might be statistically observed and arise from the program doing something non-random are covered by the injected noise. The encrypted data observed at any point in the program is statistically uniformly distributed across the full spectrum of possible values in some embodiments. It is not the case, for example, that an encryption for 2 occurs more often than is to be expected from random chance among 296 possible values anywhere in the trace even if the program does nothing but print 2s. To take advantage of the variety of fast and open Reduced Instruction Set Computer (RISC) processor cores now available, in the processor described herein each CISC machine code instruction is translated on-the-fly to a sequence of standard-format RISCV 32-bit machine code instructions plus custom additions. Translation is performed by a dynamic translation unit (DTU) that lies on the instruction memory path for the fetch stage of the pipeline. A delay of one clock cycle is introduced on the extra unit on the memory path but it may be reducible to zero in some embodiments. The embodiments described below provides the RISCV machine code subset RISC-V that supports the translations, the translation to RISCV machine code from the CISC machine code, the CISC machine code, and the DTU. The CISC machine code is necessary for mathematical security, but consists essentially of a subset of standard RISCV instructions customized within the RISCV extension format to incorporate one 128b immediate constant in every arithmetic instruction. That instruction architecture enables the required security properties are obtained. A few characteristics that a programmer/compiler implementer will appreciate about the apparatus and method disclosed herein include:
(a) the RISCV instructions physically run in an environment consisting of 128-bit wide registers and memory locations. The register/memory locations contain either (i) a 128-bit encrypted value or (ii) an unencrypted value consisting of 96 high bits of statistically randomly distributed but deterministically generated padding and a 32-bit digital payload;
(b) despite (a), to a programmer/program the environment seems to be uniformly 32-bit, with 32-bit values contained in thirty-two 32-bit registers, because the real physical representation is not programmatically accessible; and
(c) there are 64 registers but the extra 32 are only available to the RISC-V instructions generated internally in the processor by translation via the DTU from the CISC input that the programmer conceived or compiled. The contents are not persistent from one translation sequence for a CISC instruction to the next. The extra registers exist in order to avoid disturbing the registers visible to the CISC programmer.

Some in the subset of RISCV instructions internally available act arithmetically on a full 128 register bits but most act only on the lower 32 bits. Those that operate on 32-bit data will add an upper 96 bits of pseudo-random padding either automatically in parallel at the same time via a hash/padding unit next to the ALU, or via a custom 128-bit instruction run in sequence afterwards, depending on the configuration of the KPU.

The suffix ‘w’ is utilized for all those RISC-V instructions with a notionally 32-bit action when running on an embodiment. That is, when there is a RISCV64 instruction (with a ‘w’) and a RISCV32 instruction (without a ‘w’) the RISCV32 encoding is used but the ‘w’ suffix is used herein for its name. It should be appreciated that the ambiguity arises from some historical RISCV instruction set design inconsistency and current ambiguities. There are no standard RISCV logical instructions (AND, OR, XOR) that act only on 32 bits in a 64-bit platform, whereas there are arithmetic instructions (ADDW, SUBW, etc) that do (the result is sign-extended to 64 bits). Instead the same RISCV instructions AND, OR, XOR with the same encodings work both on 32 and 64 bit platforms, but act on all bits of register data in both platforms. The encrypted processor environment disclosed herein is logically 32-bit but physically 128-bit and it should be appreciated that it makes no functional difference for a logically 32-bit instruction whether 32 or more than 32 bits are actually written by the instruction as the top 96 bits of the register will be overwritten with a hash. The ‘w’ instruction naming convention used herein indicates which instructions ‘see’ only the 32 bits and which ‘see’ all 128 bits and can manipulate those too. Since RISCV128 has not crystalized yet, it is not known what designation will be utilized by 32 bit instructions in a 128 bit RISCV environment. For the embodiments described herein it is decided when there is a choice to name those instructions that see 32 bits with a ‘w’ suffix but using the most general encoding available among compatible functionalities when running in a 32 bit environment, so as not to force the issue.

Instruction sequences generated as translations of CISC source instructions as a practical matter need to access an extra upper 32 registers. To enable that with the RISCV standard instruction layout and its 5-bit register index fields, an instruction that effects register renaming may be used at the beginning of each translation sequence (and at the end, to restore the standard mapping). At most 8 or so registers in the upper 32 range of registers will be accessed in any one sequence. But it is preferred to avoid instruction renaming because of the associated instruction and cycle count hit. The embodiments instead provide alternate versions of the standard RISCV instructions with opcodes situated in the CUSTOM portions of the standard opcode map. These access the top 32 registers instead of the bottom 32.

The embodiments described below are arranged in sections. Section 2 following on from here describes the standard RISCV instruction architecture and opcode map. Section 3 describes the encrypted processor internal register layout, names and their use. Section 4 details the subset of RISCV needed to translate the CISC instructions, the latter being described in Section 5. The translations from CISC to RISCV are described in Section 6 and the DTU hardware, which does the translation, is described in Section 7.

For reference, this section describes the standard RISCV instruction architecture that encompasses the customized RISCV instruction subset implemented in the embodiments. The standard RISCV opcode map specifies 7-bit opcodes of the form xxyyy11, as below in TABLE 1. The encrypted processor opcodes follow this map apart from in one instance, assigning each encrypted processor instruction that is obviously equivalent to a standard instruction (e.g. add two registers into a third) the standard coding. The remainder, apart from that instance, are assigned opcodes in the areas of the map labeled CUSTx/RSVDx.

TABLE 1

| | 000 | 001 | 010 | 011 | 100 | 101 | 110 | 111 |
|---|---|---|---|---|---|---|---|---|
| 00 | LOAD | LOADFP | CUST0 | MISCMEM | OPIMM | AUIPC | OPIMM32 | 48b |
| 01 | STORE | STOREFP | CUST1 | AMO | OP | LUI | OP32 | 64b |
| 10 | MADD | MSUB | NMSUB | NMADD | OPFP | RSVD1 | CUST2 | 48b |
| 11 | BRANCH | JALR | RSVD2 | JAL | SYSTEM | RSVD3 | CUST3 | >79b |

There is one instruction that falls outside the scheme of this table, and that is a ‘prefix’ instruction to load a 29-bit immediate. It has 0b01 instead of the table-standard 0b11 as the final two bits of the 7-bit opcode. That disambiguates it at decode stage from the standard instruction formats. Four prefix instructions in sequence will push 116 bits into the top of a 128-bit accumulator register and then a following standard RISCV instruction with a 12-bit immediate finishes the load. An alternative would be to load constant data into memory and read it to registers from there, but constant data is an ingredient in each of the CISC source instructions and it is preferable not to introduce memory-associated delays or remedies such as cache preloading.

The standard main RISCV instruction layouts are called R,I,B and S and their 7-bit opcodes all end in 11. Table 2 shows the physical layout in bigendian order (it will be appreciated that in other embodiments littleendian may be utilized for the physical layout). Bigendian, the most significant bit of each field and the whole instruction is at left, as it is when we write a number in decimal: 1234 has the 1 as the most significant digit and it is at left. Other than the OP7 opcode, there is a 3-bit FN3 function field, and for those instructions without an immediate constant occupying that space in the instruction, also a 7-bit FN7 function field:

TABLE 2

| | OP7 | | FN3 | | | FN7 |
|---|---|---|---|---|---|---|
| | 7 | 5 | 3 | 5 | 5 | 7 |
| std R | opcode₆₋₂[11] | ${r}_{4 - 0}^{d}$ | f₂₋₀ | ${r}_{4 - 0}^{{s}_{1}}$ | ${r}_{4 - 0}^{{s}_{2}}$ | k₆₋₀ |
| std I | opcode₆₋₂[11] | ${r}_{4 - 0}^{d}$ | f₂₋₀ | ${r}_{4 - 0}^{s}$ | i₁₁₋₀ | |
| std B | opcode₆₋₂[11] | i₁₀i₃₋₀ | f₂₋₀ | ${r}_{4 - 0}^{{s}_{1}}$ | ${r}_{4 - 0}^{{s}_{2}}$ | i₉₋₄i₁₁ |
| std S | opcode₆₋₂[11] | i₄₋₀ | f₂₋₀ | ${r}_{4 - 0}^{{s}_{1}}$ | ${r}_{4 - 0}^{{s}_{2}}$ | i₁₁₋₅ |

It should be appreciated that decoding keys off the OP7 field first (least significant two bits examined first), then the FN3 and possibly FN7 fields. The R, I, B forms are basic, and the S form is a variant of B. There is also a J format, but it is not used by any instruction in the RISCV subset used by the encrypted processor.

To address 64 registers instead of 32, analogues of the standard instructions with opcodes OP7 in the CUSTOM areas of the standard table are used. The latter have the same format as the corresponding standard instruction but different opcode/function fields. Three bits of the FN3 and FN7 fields in the custom instructions are used to designate whether the corresponding register index references the lower or upper 32 of the available registers, following the pattern in Table 3:

TABLE 3

| | OP7 | | FN3 | | | FN7 | | | | |
|---|---|---|---|---|---|---|---|---|---|---|
| | 7 | 5 | 3 | 5 | 5 | 7 | | | | |
| CUST R | opcode₆₋₀[11] | ${r}_{4 - 0}^{d}$ | f₂₋₀ | ${r}_{4 - 0}^{{s}_{1}}$ | ${r}_{4 - 0}^{{s}_{2}}$ | ${r}_{5}^{d}$ | k₅ | ${r}_{5}^{{s}_{1}}$ | ${r}_{5}^{{s}_{2}}$ | k₂₋₀ |

| CUST I | opcode₆₋₀[11] | ${r}_{4 - 0}^{d}$ | ${r}_{5}^{d}$ | f₁ | ${r}_{5}^{s}$ | ${r}_{4 - 0}^{s}$ | i₁₁₋₀ | |
|---|---|---|---|---|---|---|---|---|
| CUST B | opcode₆₋₀[11] | i₁₀i₃₋₀ | ${r}_{5}^{{s}_{1}}$ | f₁ | ${r}_{5}^{{s}_{2}}$ | ${r}_{4 - 0}^{{s}_{1}}$ | ${r}_{4 - 0}^{{s}_{2}}$ | i_{9- 4}i₁₁ |
| CUST S | opcode₆₋₀[11] | i₄₋₀ | ${r}_{5}^{{s}_{1}}$ | f₁ | ${r}_{5}^{{s}_{2}}$ | ${r}_{4 - 0}^{{s}_{1}}$ | ${r}_{4 - 0}^{{s}_{2}}$ | i₁₁₋₅ |

It should be appreciated that the rₛ bit set signifies the r₄₋₀ field references the upper 32 registers, unset signifies it references the lower 32.

The following section describes the layout and conventional use (API) of the processor's register set. There are 32+32 126-bit wide registers. Many registers are paired with a partner register for use with double length arithmetic instructions. Double length arithmetic instructions index only the first register of a pair. The first register contains the high bits and the second contains the low bits. Each register will contain a 32-bit payload and a 96-bit hash, if in unencrypted form, else an encryption of that. Among the lower thirty-two registers, the t(2n) and t(2n+1) registers are pairs, as are the c2n and c(2n+1) registers, the a2n and a(2n+1) registers, and the v2n and v (2n+1) registers. In the upper thirty-two registers, registers t8, 19 are a pair, and so are registers maclo, machi and x0, x1. If a double length CISC arithmetic instruction indexes a register that is not first of a pair, it will be taken as paired with the ‘illr’ register index number 31 of the upper thirty-two and will end up being treated as an illegal instruction further along the pipeline. For single length arithmetic instructions, the register pairings are not significant. Any of a pair can be used singly without restriction in some embodiments. The lower 32 registers are accessible directly from the CISC instruction interface and are named and used as follows in TABLE 4:

TABLE 4

| index | name | purpose |
|---|---|---|
| 0 | zer | zero reference (writable, rarely used) |
| 1 | sp | stack pointer |
| 2 | fp | frame pointer |
| 3 | a0 | function argument |
| 4 | a1 | function argument |
| 5 | a2 | function argument |
| 6 | a3 | function argument |
| 7 | a4 | function argument |
| 8 | a5 | function argument |
| 9 | ra | return address |
| 10 | c0 | caller clears |
| 11 | v0 | function return value |
| 12 | v1 | function return value |
| 13 | v2 | function return value |
| 14 | v3 | function return value |
| 15 | c1 | caller clears |
| 16 | t0 | temporary |
| 17 | c2 | caller clears |
| 18 | t1 | temporary |
| 19 | c3 | caller clears |
| 20 | t2 | temporary |
| 21 | c4 | caller clears |
| 22 | t3 | temporary |
| 23 | c5 | caller clears |
| 24 | t4 | temporary |
| 25 | c6 | caller clears |
| 26 | t5 | temporary |
| 27 | c7 | caller clears |
| 28 | t6 | temporary |
| 29 | c8 | caller clears |
| 30 | t7 | temporary |
| 31 | c9 | caller clears |

The zer register name is a holdover from classical RISC architectures that expect a non-writable register containing the zero value. For security in these embodiments the register must not contain any special value and must be readable and writable like any other register. It will generally be used to contain a common base value in a short consecutive sequence of calculations. An obfuscating compiler will take every opportunity to modify it. The ra register name is another holdover from classical RISC. It is not used for its classical purpose of containing function call return addresses here (which are not accessible via the CISC interface and the ra register can be used for any purpose. The temporary registers are intended for scratchpad calculations. The programmer should always be aware that assembler-level macros may step on them. They are suitable for use within code sequences that do not include a function call, and may be changed during a function call. They will not be changed by an interrupt as registers are copied automatically by the embodiments to private storage on interrupt and restored them on return from the interrupt handler.

The caller clear registers c1 to c9 are temporaries for which the caller reserves responsibility for save and restore on a function call. A callee should not attempt to save and restore these for its parent, but will do so for a function it calls in some embodiments. Other registers can be saved and restored by a callee as required in some embodiments. This standard programming convention shares out the burden of save and restore around a function call. All these registers will contain data at runtime that is either (encrypted) data or (encrypted) data addresses, never program addresses, encrypted or unencrypted, nor unencrypted data.

The upper thirty-two registers are a mix of those reserved for use within instruction translation sequences in the pipeline, and system configuration registers that have special functions. The reserved registers may possibly be cleared automatically between different instruction translation sequences, except for the Ink register, which contains a program function call return address. The system configuration registers among the upper 32 are mapping for convenience of a particular few of the 4096 configuration/status registers (CSRs) available in a RISC-V architecture. Those are indicated by an entry in the ‘system’ column in Table 5 below.

TABLE 5

| index | name | purpose | system |
|---|---|---|---|
| 32 | xer | zero | — |
| 33 | t8 | temporary | — |
| 34 | t9 | temporary | — |
| 35 | maclo | accumulator low bits | — |
| 36 | machi | accumulator high bits | — |
| 37 | x0 | extra | — |
| 38 | x1 | extra | — |
| — | fpcsr | floating point control/status (unused) | 39 |
| 40 | unkn | unknown (unused) | — |
| — | esr | saved status | 41 |
| — | epcr | saved program counter | 42 |
| — | eear | saved arithmetic exception control (unused) | 43 |
| — | aecr | arithmetic exception control (unused) | 44 |
| — | aesr | arithmetic exception status (unused) | 45 |
| — | dtlbeir | data TLB entry invalidate (unused) | 46 |
| — | dtlbtr | data TLB translate (unused) | 47 |
| — | dtlbmr | data TLB match (unused) | 48 |
| — | sr | processor control/status | 49 |
| — | immucr | instruction MMU control | 50 |
| — | dmmucr | data MMU control | 51 |
| 52 | sfr | status flag | — |
| 53 | pc | program counter | — |
| 54 | lnk | link program address | — |
| 55 | pc1 | program counter plus one | — |
| 56 | cns | instruction constant | — |
| 57 | acc | instruction constant accumulator | — |
| 58 | acd | instruction constant accumulator | — |
| 59 | ace | instruction constant accumulator | — |
| — | rm | register renaming map | 60 |
| 61 | cA | caller clears | — |
| 63 | illr | illegal | — |

All 32 of this upper register set are not directly accessible via the CISC instructions, which can only reference the 32 in the lower register set. The t8, 19 pair are temporary registers, The cA register is a temporary register controlled by the function or subroutine caller (i.e., it holds data of the caller to be accessed by a callee). The x0, x1 registers are an ‘eXtra’ pair for arbitrary use. The maclo, machi pair's names are holdovers from classical RISC and they are not reserved for special use in the embodiments. The unkn register is never referenced by an instruction in some embodiments. The sfr register contains the flag set by a conditional instruction and should be tested for a zero or nonzero value. The program counter register when read shows the address of that instruction. A write to the program counter register is intercepted and sent to the fetch stage as if a jump instruction had been executed but it is preferred that jump and branch instructions. On read, the pc1 register shows the address of the next instruction after the current instruction and writing to it does nothing in some embodiments. The pc and pc1 registers count in (32-bit) instruction words, not bytes, as do all registers that contain instruction addresses. The Ink register contains the return address after a jump to a subroutine. The cns register is for internal use in translation sequences of CISC instructions and it contains the immediate constant if there is one in the CISC instruction. The registers acc, acd and ace are written by the prefix instruction. Each prefix instruction loads 29 bits of a 128-bit constant, doing shift and push into the accumulator registers. Subsequent instructions may interrogate acc, acd, ace for the accumulated constants. The xer register on read provides a zero value, substituting for the classical zer register. The xer register can be read from but not written to. The illr register cannot be read and an illegal instruction fault will be triggered if an instruction tries to. It may be used by translation of an illegal CISC instruction configurations in some embodiments. It is also a safe place to discard data to.

Some standard RISCV configuration status registers (CSRs) have been mapped into the upper 32 registers. This section describes their layout and use. It should be appreciated that some of these register functions and layouts have been brought over from classical RISC and pre RISCV implementations, and the RISCV may differ slightly. The fpcsr register (unused) controls/monitors the floating point unit. Care is taken in the translations from CISC to RISC-V that this register and others CSRs are not made accessible via CISC instructions, nor is their state observable via indirect effects (e.g., bytriggering an interrupt on divide by zero when in one state but not when in another). The esr register saves a copy of the processor status/control register on interrupt and it is not programmatically accessible from the CISC interface. Similarly, the epcr register saves a copy of the program counter on interrupt, and the eear register (unused) saves a copy of the arithmetic logic unit's exception status. The aecr register (unused) controls the arithmetic logic unit's delivery of exceptions. As designed, the encrypted processor's ALU never faults so there is no specific need. On division by zero it returns a false result and overflows and underflows are ignored. The aesr register (unused) in theory would record the exception and carry and overflow flags but those are not made available by the ALU in the encrypted processor. Instead carry and overflow can be predicted programmatically. The dtlbeir, dtlbtr and dtlbmr registers (unused) could be used to access the custom hardware translation lookaside buffer (TLB) that does address translation from 128b to 32b on the fly but it is preferred that access to the TLB is instead via the custom SETA, UNSA instructions in order to simplify implementations. Those instructions being synchronous: they wait the requisite amount of time for the TLB to finish each operation. The dtlbtr register is where an address may be written for translation by the TLB and the dtlbmr register is where the translation may be read. The dtlbeir register is where an address would be written to invalidate TLB entry. It is preferred however to reset all TLB entries at once. The rm register contains the register name map. It is initialized with the lower 32 bits set to 0. That means that 5-bit register indices in standard instructions access the lower 32 registers. Setting the i^{th} bit in the map to 1 means that register index i instead accesses the corresponding register in the upper 32 registers, which has index i+32. The upper 32 bits of the map are initialized to 1 and clearing some of them would have the effect of making custom instructions that should access the upper 32 registers instead access the lower 32 registers which is not preferred. Writing the map may require an explicit pipeline flush (RISC ‘fence’ instruction or jump to the next instruction address) following immediately after.

The sr register is the control register for the processor state. The SM bit controls the processor mode: user or administrator mode (i.e. unprivileged and privileged, respectively: only two modes are needed). There are 32 classically defined bits and the rest are for internal use in the pipeline. The legacy lower 32 bits are as follows in TABLE 6:

TABLE 6

| bit | name | purpose |
|---|---|---|
| 0 | SM | Supervisor mode |
| 1 | TEE | Tick timer exception enable |
| 2 | IEE | Interrupt exception enable |
| 3 | DCE | Data cache enable (unused) |
| 4 | ICE | Instruction cache enable (unused) |
| 5 | DME | Data MMU enable |
| 6 | IME | Instruction MMU enable |
| 7 | LEE | Little endian enable (unused) |
| 8 | CE | CID enable (unused) |
| 9 | F | Condition flag (unused) |
| 10 | CY | Carry flag (unused) |
| 11 | OV | Overflow flag (unused) |
| 12 | OVE | Overflow flag exception (unused) |
| 13 | DSX | Delay slot exception (unused) |
| 14 | EPH | Exception prefix high (unused) |
| 15 | FO | Fixed one (unused) |
| 16 | SUMRA | Supervisor SPR read access (unused) |
| 17-27 | RES | Reserved |
| 28-31 | CID | Context ID |

The legacy bits are either not functional or have been moved to another register in some embodiments. The condition flag is available as the sfr register. The supervisor mode bit and exception enable bits are the only bits of the status register that are functional. The status register is automatically saved and restored on interrupt. The immucr and dmmucr registers communicate with the classical instruction and data MMUs respectively. Writing those registers sets the position in memory and size of the page translation tables. The next instruction will see the altered tables. The data written to the dmmucr has the following format, bitwise:

| bit | name | purpose |
|---|---|---|
| 0 | DTF | DTLB flush |
| 1-9 | SIZ | log page table size in KB |
| 10-31 | PTBP | 22 bit page table base address in KB |

The page table can be placed anywhere in the first 4 GB of memory. Writing 0x1800 to the dmmucr sets fields 6.0.0, meaning no flush, table size is 2⁰ KB, i.e. 1 KB, and the table starts 6 KB above zero, at address 0x1800 counted in bytes. Because the table size is set at 1 KB, the table ends at address 0x1c00, 7 KB above zero. Usually, a table will be some MB in size and be placed near the top of memory and similarly for the immucr register. Page table entries can then be written directly to the tables in memory. The embodiments will snoop writes of page table entries to the tables and load its internal dTLB or iTLB caches from them. Instruction/data page address translation is not active in supervisor mode so writing dmmucr or immucr should leave supervisor mode running unaffected. The registers cannot be written from user mode in some embodiments. The data and instruction page table entries are 32 bits each. They are placed in the page table area at an offset (counted in 32-bit words) corresponding to the logical page number. The bits of the dmmucr or immucr registers define flags for the page (read-only, executable, etc) and the physical device number for the target of the mapping and the physical page number on that device. Most of the flag bits are not functional in the encrypted processor. The layout of data and instruction page entries are as follows in TABLE 7:

TABLE 7

| | data | TLB page table entry | | iinstruction | TLB page table entry |
|---|---|---|---|---|---|
| bit | name | purpose | bit | name | purpose |
| 0 | CC | cache coherency | 0 | CC | cache coherency |
| 1 | CI | cache inhibit | 1 | CI | cache inhibit |
| 2 | DID0 | device identifier 0 | 2 | DID0 | device identifier 0 |
| 3 | DID1 | device identifier 1 | 3 | DID1 | device identifier 1 |
| 4 | A | accessed | 4 | A | accessed |
| 5 | D | dirty | 5 | D | dirty |
| 6 | URE | user read enable | 6 | UXE | user execute enable |
| 7 | UWE | user write enable | 7 | RSV7 | reserved |
| 8 | SRE | supervisor read enable | 8 | SXE | supervisor execute enable |
| 9 | SWE | supervisor write enable | 9 | RSV9 | reserved |
| 10-31 | PPN | physical page number | 10-31 | PPN | physical page number |

Up to for four target device indexed 0-3 may be designated via the two bits {DID0} {DID1} in each page table entry. The target device may do further mapping. The canonical targets are respectively the system memory, the peripheral controller, the 128-bit to 32-bit TLB conversion unit, and the key manager.

Initial page table entries for the encrypted processor are typically loaded to a location high in the first page (8 KB) of memory as part of the BIOS image, and the startup code (in sector 0 of that first page i.e., the first 512B) sets the dmmucr and immucr to point to them. The initial page tables will typically later be replaced during operating system initialization. The location of page tables in memory and their entries are not in any way secret and do not need securing in some embodiments. Changing the instruction page table may cause a user program not to run but a system administrator can achieve that by switching off the machine. If the system administrator changes the instruction page table to point to a different user program, that may be detected by the user, and at worst the program will not run if the user has changed their key. Changing the data page table may cause the user program to read and write the (encrypted) user data from/to a different place in memory, and that may also be detected by the user. The physical page numbers in the page table entries are 22 bits long, which with 8 KB pages allows 32 GB bits of address space to be mapped per target device. The page size is typically set at 8 KB the better to accommodate 128 bit data. One page of memory at that size contains 2048 instruction words (32-bit) or 512 data words (128-bit) in some embodiments. While 4 KB or 8 KB pages are typical for operating systems, the dmmucr and immucr SIZ field allows for up to 2⁵¹¹ KB pages.

This section describes the subset of RISC-V machine code instructions used in the DTU for the translations of CISC machine code instructions. This section is divided into parts, first the twenty or so custom instructions dealing with encryption/decryption, then the three instructions for memory access, the two custom register-register instructions, and the two conditional small jump instructions. Encryption/decryption is effected via instructions with opcodes in the CUST0 range of the RISCV opcode map of Table 1, intended for conforming extensions. The instructions are as follows:
(i) The decrX(r, s) instructions run AES decryption round X on the 128-bit value in register s using the current encryption key, writing the 128-bit result in register r. The encrX(r, s) instructions run encryption round X.
(ii) The getkd(r, s) instruction interrogates the crypto cache for the decryption of the 128-bit value in register s and puts the 128-bit result in register r if it is in cache and sets the special flag register sfr to 1. If it is not in cache, it returns 0 and sets sfr to 0. The getke(r, s) instruction does the same but for encryption instead of decryption.
(iii) The putkd(s, t) instruction expects an encrypted 128-bit value in register t and its decryption in register s, and loads the crypto cache with that information. An older entry (oldest in the same cache line) may be lost from cache. The putke(s, t) instruction does the same but with the encrypted value in s and its decryption in t. It is the same as putkd(t, s).

These custom instructions conform to the RISCV R format described below. The top bit for a 6-bit register index occupies a position in the 7-bit function code field. A bit signifying a register index bit is shown as ‘r’ in TABLE 8, a bit that is ignored is shown as

TABLE 8

| | | | 7 | 5 | 3 | 5 | 5 | 7 | | | | |
|---|---|---|---|---|---|---|---|---|---|---|---|---|
| instruction | opcode name | form | opcode val | ${r}_{4 - 0}^{d}$ | f₂₋₀ | ${r}_{4 - 0}^{s}$ | ${r}_{4 - 0}^{t}$ | ${r}_{5}^{d}$ | k₅ | ${r}_{5}^{s}$ | ${r}_{5}^{t}$ | k₂₋₀ |
| decr1 r^{d}, r^{s} | CUST0_DECR1 | R | 00_010_11 | rrrrr | 000 | rrrrr | - - - - - | r | 0 | r | 0 | 001 |
| decr2 r^{d}, r^{s} | CUST0_DECR2 | R | 00_010_11 | rrrrr | 000 | rrrrr | - - - - - | r | 0 | r | 0 | 010 |
| decr3 r^{d}, r^{s} | CUST0_DECR3 | R | 00_010_11 | rrrrr | 000 | rrrrr | - - - - - | r | 0 | r | 0 | 011 |
| decr4 r^{d}, r^{s} | CUST0_DECR4 | R | 00_010_11 | rrrrr | 000 | rrrrr | - - - - - | r | 0 | r | 0 | 100 |
| decr5 r^{d}, r^{s} | CUST0_DECR5 | R | 00_010_11 | rrrrr | 000 | rrrrr | - - - - - | r | 0 | r | 0 | 101 |
| decr6 r^{d}, r^{s} | CUST0_DECR6 | R | 00_010_11 | rrrrr | 000 | rrrrr | - - - - - | r | 0 | r | 0 | 110 |
| decr7 r^{d}, r^{s} | CUST0_DECR7 | R | 00_010_11 | rrrrr | 000 | rrrrr | - - - - - | r | 0 | r | 0 | 111 |
| decr8 r^{d}, r^{s} | CUST0_DECR8 | R | 00_010_11 | rrrrr | 000 | rrrrr | - - - - - | r | 1 | r | 0 | 000 |
| decr9 r^{d}, r^{s} | CUST0_DECR9 | R | 00_010_11 | rrrrr | 000 | rrrrr | - - - - - | r | 1 | r | 0 | 001 |
| decrA r^{d}, r^{s} | CUST0_DECRA | R | 00_010_11 | rrrrr | 000 | rrrrr | - - - - - | r | 1 | r | 0 | 010 |
| getkd r^{d}, r^{s} | CUST0_GETKD | R | 00_010_11 | rrrrr | 000 | rrrrr | - - - - - | r | 1 | r | 0 | 011 |
| putkd r^{d}, r^{s} | CUST0_PUTKD | R | 00_010_11 | - - - - - | 000 | rrrrr | rrrrr | 0 | 1 | r | r | 100 |
| encr1 r^{d}, r^{s} | CUST0_ENCR1 | R | 00_010_11 | rrrrr | 001 | rrrrr | - - - - - | r | 0 | r | 0 | 001 |
| encr2 r^{d}, r^{s} | CUST0_ENCR2 | R | 00_010_11 | rrrrr | 001 | rrrrr | - - - - - | r | 0 | r | 0 | 010 |
| encr3 r^{d}, r^{s} | CUST0_ENCR3 | R | 00_010_11 | rrrrr | 001 | rrrrr | - - - - - | r | 0 | r | 0 | 011 |
| encr4 r^{d}, r^{s} | CUST0_ENCR4 | R | 00_010_11 | rrrrr | 001 | rrrrr | - - - - - | r | 0 | r | 0 | 100 |
| encr5 r^{d}, r^{s} | CUST0_ENCR5 | R | 00_010_11 | rrrrr | 001 | rrrrr | - - - - - | r | 0 | r | 0 | 101 |
| encr6 r^{d}, r^{s} | CUST0_ENCR6 | R | 00_010_11 | rrrrr | 001 | rrrrr | - - - - - | r | 0 | r | 0 | 110 |
| encr7 r^{d}, r^{s} | CUST0_ENCR7 | R | 00_010_11 | rrrrr | 001 | rrrrr | - - - - - | r | 0 | r | 0 | 111 |
| encr8 r^{d}, r^{s} | CUST0_ENCR8 | R | 00_010_11 | rrrrr | 001 | rrrrr | - - - - - | r | 1 | r | 0 | 000 |
| encr9 r^{d}, r^{s} | CUST0_ENCR9 | R | 00_010_11 | rrrrr | 001 | rrrrr | - - - - - | r | 1 | r | 0 | 001 |
| encrA r^{d}, r^{s} | CUST0_ENCRA | R | 00_010_11 | rrrrr | 001 | rrrrr | - - - - - | r | 1 | r | 0 | 010 |
| getke r^{d}, r^{s} | CUST0_GETKE | R | 00_010_11 | rrrrr | 001 | rrrrr | - - - - - | r | 1 | r | 0 | 011 |
| putke r^{s}, r^{t} | CUST0_PUTKE | R | 00_010_11 | - - - - - | 001 | rrrrr | rrrrr | 0 | 1 | r | r | 100 |

| | | | | | | |
|---|---|---|---|---|---|---|
| std R | opcode val | ${r}_{4 - 0}^{d}$ | f₂₋₀ | ${r}_{4 - 0}^{s}$ | ${r}_{4 - 0}^{t}$ | k₆₋₀ |

These instructions may be used to decrypt the contents of register s into register r as follows:

| | |
|---|---|
| getkd r,s | # try cache for decryption first |
| cskip sfr,11 | # skip explicit decryption if was cached |
| decr1 r,s | # explicit decryption ... |
| decr2 r,r | |
| ... | |
| decrA r,r | |
| putkd r,s | # cache the new decryption |

There is also a custom I-format variant of the decr1 instruction that takes a 12-bit immediate constant at the instruction as depicted below:

| | | | 7 | 5 | 3 | | | 5 | 12 |
|---|---|---|---|---|---|---|---|---|---|
| instruction | opcode name | form | opcode val | ${r}_{4 - 0}^{d}$ | ${r}_{5}^{d}$ | f₁ | ${r}_{5}^{s}$ | ${r}_{4 - 0}^{s}$ | i₁₁₋₀ |
| decr1i r^{d}, r^{s}, i | CUST0_DECR1I | I | 01_010_11 | rrrrr | r | 1 | r | rrrrr | iiiii_iiiiiii |

| | | | | | |
|---|---|---|---|---|---|
| std I | opcode val | ${r}_{4 - 0}^{d}$ | f₂₋₀ | ${r}_{4 - 0}^{s}$ | i₁₁₋₀ |

This instruction is used to load a 128-bit encrypted immediate value k′ for decryption into register r as follows. It requires four preceding prefix instructions. The prefix instructions push 29 bits into the acc register as follows:

| | |
|---|---|
| prfx k₁₂₇₋₉₉ | # load 29 top bits of 128 |
| prfx k₉₈₋₇₀ | # load 29 more bits |
| prfx k₆₉₋₄₁ | # load 29 more bits |
| prfx k₄₀₋₁₂ | # load 29 more bits |
| decr1i r,acc,k₁₁₋₀ | # load 12 low bits and start decryption ... |

The prefix instructions leave a 12-bit space at the low end of the 128-bit accumulator register acc, and the decr1i instruction fits its 12-bit immediate into that space, then runs decryption round 1. The decr1(r, s) instruction is equivalent to decr1i(r, s, 0). There is likewise a variant with a 12-bit immediate constant in RISCV I-format, getkdi(r,s,i), of the getkd(r,s) instruction. The format is shown in the Table below. This adds the 12-bit immediate i′₁₁₋₁₀ into the low end of register s before looking in the crypto cache for the encryption of I′ with i, with return of I′ in register r if successful. Cach lookup success/failure is recorded as I/O respectively in the sfr register. The getkd(r,s) instruction is equivalent to getkdi(r,s,0).

| | | | 7 | 5 | 3 | | | 5 | 12 |
|---|---|---|---|---|---|---|---|---|---|
| instruction | opcode name | form | opcode val | ${r}_{4 - 0}^{d}$ | ${r}_{5}^{d}$ | f₁ | ${r}_{5}^{s}$ | ${r}_{4 - 0}^{s}$ | i₁₁₋₀ |
| getkdi r^{d}, r^{s}, i | CUST1_GETKDI | I | 01_010_11 | rrrrr | r | 1 | r | rrrrr | iiiii_iiiiiii |

| | | | | | |
|---|---|---|---|---|---|
| std I | opcode val | ${r}_{4 - 0}^{d}$ | f₂₋₀ | ${r}_{4 - 0}^{s}$ | i₁₁₋₀ |

There is also a variant with a 12-bit constant putkdi(r,s,i) of the putkdi(r,s) instruction. It adds the final 12 bits into register s and loads the crypto cache with I′ from s and its decryption I as found in register r. The instruction putkd(r,s) equivalent to putkdi(r,s,0) is in S format as shown below:

| | | | 7 | 5 | 3 | | | 5 | 5 | 7 |
|---|---|---|---|---|---|---|---|---|---|---|
| instruction | opcode name | form | opcode val | i₄₋₀ | ${r}_{5}^{s 1}$ | f₁ | ${r}_{5}^{s 2}$ | ${r}_{4 - 0}^{s 1}$ | ${r}_{4 - 0}^{s 2}$ | i₁₁₋₅ |
| putkdi r^{d}, r^{s}, i | CUST1_PUTKDI | S | 01_010_11 | iiiii | r | 0 | r | rrrrr | rrrrr | iiiiiii |

| | | | | | | |
|---|---|---|---|---|---|---|
| std S | opcode val | i₄₋₀ | f₂₋₀ | ${r}_{4 - 0}^{s 1}$ | ${r}_{4 - 0}^{s 2}$ | i₁₁₋₅ |

The canonical use of these latter two instructions together with decr1i is in a sequence that decrypts a 128-bit immediate supplied via four prefix instructions but which also first checks and then possibly updates the crypto cache, as follows:

| | |
|---|---|
| prfx k127 - 99 | # load 29 top bits of 128 |
| prfx k98 - 70 | # load 29 more bits |
| prfx k69 - 41 | # load 29 more bits |
| prfx k40 - 12 | # load 29 more bits |

| | |
|---|---|
| getkdi r,acc,k11 - 0 | # load 12 low bits and check |
| cache for decryption cskip sfr,11 | # skip explicit |

decryption if decryption was cached decr1i r,acc,k11 - 0

# load 12 low bits and start explicit

decryption ... decr2 r,r
...

| | |
|---|---|
| decrA r,r | # end explicit decryption |

| | |
|---|---|
| putkdi r,acc,k11 - 0 | # store decryption pair in cache |

...

In supervisor mode, the encrX/decrX instructions do mothing. That is, they act as though the encryption and decryption rounds X were no-ops. In supervisor mode, the getkd/getke instructions that interrogate the crypto cache in user mode just copy input to output and set the flag register, as though cache lookup had occurred and been successful. The putkd/putke instructions are no-ops in supervisor mode.

The standard RISCV 32-bit load and store instructions add an immediate constant to the address before memory access. In the setting of these embodiments even adding a zero can change the 96-bit padding on an address, affecting the encrypted value. For better control, the embodiments use custom versions of load and store instructions that do not add an immediate to the address. These instructions are get(r,s) and put(r,s), corresponding respectively to standard RISCV lq r,0[s] (load quad word) and sq 0[r],s (store quad word).

The get(r,s) instruction copies the 128-bit content of the memory at the 32-bit address con-tained in the low bits of register s to register r. The put(r,s) instruction copies the content of 128-bit register s to memory at the 32-bit address contained in the low bits of register r. Table 9 sets out the format of the get and put instructions.

TABLE 9

| | | | 7 | 5 | 3 | 5 | 5 | 7 | | | | |
|---|---|---|---|---|---|---|---|---|---|---|---|---|
| instruction | opcode name | form | opcode val | ${r}_{4 - 0}^{d}$ | f₂₋₀ | ${r}_{4 - 0}^{s}$ | ${r}_{4 - 0}^{t}$ | ${r}_{5}^{d}$ | k₅ | ${r}_{5}^{s}$ | ${r}_{5}^{t}$ | k₂₋₀ |
| get r^{d}, r^{s} | CUSTO_GET | R | 00_010_11 | rrrrr | 100 | rrrrr | - - - - - | r | 0 | r | 0 | 000 |
| put r^{s}, r^{t} | CUSTO_PUT | R | 00_010_11 | - - - - - | 101 | rrrrr | rrrrr | 0 | 0 | r | r | 000 |

| | | | | | | |
|---|---|---|---|---|---|---|
| std R | opcode val | ${r}_{4 - 0}^{d}$ | f₂₋₀ | ${r}_{4 - 0}^{s}$ | ${r}_{4 - 0}^{t}$ | k₆₋₀ |

To obtain a 32-bit address in order to store or retrieve data to/from it, a 128-bit encrypted address is submitted by the instruction seta(r) to the special Translation Lookaside Buffer (TLB) unit in the embodiments described herein. The 128-bit encrypted address is placed in register r, and a 32-bit mapping for it is returned in the same register. The TLB may generate a memory fault when its internal database is full, and then its functionality should be executed in software by an exception handler instead. The TLB's internal database is mapped into or is part of general system memory and accessible via ordinary RISCV load and store instructions in supervisor mode. The information in the TLB database is not secret. It may safely be observed by the system administrator and/or supervisor mode programs as it is created, and may safely be manipulated by the system and/or a supervisor mode exception handler. The Table below shows the seta instruction format.

| | | | 7 | 5 | 3 | 5 | 5 | 7 | | | | |
|---|---|---|---|---|---|---|---|---|---|---|---|---|
| instruction | opcode name | form | opcode val | ${r}_{4 - 0}^{d}$ | f₂₋₀ | ${r}_{4 - 0}^{s}$ | ${r}_{4 - 0}^{t}$ | ${r}_{5}^{d}$ | k₅ | ${r}_{5}^{s}$ | ${r}_{5}^{t}$ | k₂₋₀ |
| seta r^{d} | CUSTO_SETA | R | 00_010_11 | rrrrr | 101 | - - - - - | - - - - - | r | 0 | 0 | 0 | 100 |

| | | | | | | |
|---|---|---|---|---|---|---|
| std R | opcode val | ${r}_{4 - 0}^{d}$ | f₂₋₀ | ${r}_{4 - 0}^{s}$ | ${r}_{4 - 0}^{t}$ | k₆₋₀ |

The foregoing instructions enable plaintext consisting of 96 bits of padding and 32 bits of data held in register r to be stored encrypted in memory at a uniquely mapped replacement for an encrypted address, the 32-bit plaintext plus 96 bits padding for which is held in register s, as follows:

| | |
|---|---|
| getke t1,r | # encrypt 32b data plus padding in r into register t1 |
| cskip sfr,11 | # . |
| encr1 t1,r | # . |
| encr2 t1,t1 | # . |
| ... | |
| encrA t1,t1 | # . |
| putkd t1,r | # . |
| getke t2,s | # encrypt 32b address plus padding in s into register t2 |
| cskip sfr,11 | # . |
| encr1 t2,s | # . |
| encr2 t2,t2 | # . |
| ... | |
| encrA t2,t2 | # . |
| putke t2,s | # . |
| seta t2 | # obtain 32b replacement for the 128b encrypted address |
| put t1,t2 | # write encrypted data at the 32b replacement address |

Storing not data but a program address held in register r at the encrypted address held in register s requires only the above sequence from the second stanza on. Program addresses are never encrypted (the plaintext value is known to within a certain range, creating a cryptographic vulnerability). Getting encrypted data back from memory takes the sequence of instructions below:

| | |
|---|---|
| getke t2,s | # encrypt 32b address plus padding in s into register t2 |
| cskip sfr,11 | # . |
| encr1 t2,s | # . |
| encr2 t2,t2 | # . |
| ... | |
| encrA t2,t2 | # . |
| putke t2,s | # . |
| seta t2 | # obtain 32b replacement for the encrypted address |
| get t1,t2 | # read encrypted data from the 32b replacement address |
| getkd r,t1 | # decrypt data into register r |
| cskip sfr,11 | # . |
| decr1 r,t1 | # . |
| decr2 r,r | # . |
| ... | |
| decrA r,r | # . |
| putkd r,t1 | # . |

To retrieve a program address, which is held unencrypted in memory, the tail end of the sequence above is elided from getkd r, t1 on.

The fence zer,zer,0b11111 1110000 instruction is used when a memory barrier is required. Implementations may differ as to the arguments. The bits that are set in the immediate constant denote different kinds of blocking according to the RISCV standard, not all or even some of which may necessarily be implemented in these embodiments, or any other RISCV implementation. The format of the fence instruction is shown below.

| instruction | opcode name | form | opcode val | ${r}_{4 - 0}^{d}$ | ${r}_{5}^{d}$ | f₁ | ${r}_{5}^{s}$ | ${r}_{4 - 0}^{s}$ | i₁₁₋₇ | i₆₋₀ |
|---|---|---|---|---|---|---|---|---|---|---|
| fence | MISCMEM_FENCE | I | 00_011_11 | - - - - - | 0 | 0 | 1 | - - - - - | 11111 | 1110000 |

| | | | | | | |
|---|---|---|---|---|---|---|
| std I | opcode val | ${r}_{4 - 0}^{d}$ | f₂₋₀ | ${r}_{4 - 0}^{s}$ | i₁₁₋₇ | i₆₋₀ |

The fence instruction with zero as the 12-bit immediate may be used as a no-op instruction.

Standard RISCV does not provide a conditional copy instruction, but one is required in the translations of some CISC instructions. The custom cmov(s,r1,r2) instruction moves data either from register r1 or r2 respectively to register s according to whether the flag register sfr is set or not. The custom instruction mov(s,r) is functionally equivalent to cmov(s,r,r) but it no runtime data dependence on the flag register sfr and hence may execute faster. The format of the cmov and mov instructions are shown below.

| | | | 7 | 5 | 3 | 5 | 5 | 7 | | | | |
|---|---|---|---|---|---|---|---|---|---|---|---|---|
| instruction | opcode name | form | opcode val | ${r}_{4 - 0}^{d}$ | f₂₋₀ | ${r}_{4 - 0}^{s}$ | ${r}_{4 - 0}^{t}$ | ${r}_{5}^{d}$ | k₅ | ${r}_{5}^{s}$ | ${r}_{5}^{t}$ | k₂₋₀ |
| cmov r^{d}, r^{s}, r^{t} | CUSTO_CMOV | R | 00_010_11 | rrrrr | 101 | rrrrr | rrrrr | r | 0 | r | r | 110 |
| mov r^{d}, r^{s} | CUSTO_MOV | R | 00_010_11 | rrrrr | 101 | rrrrr | - - - - - | r | 0 | r | 0 | 111 |

| | | | | | | |
|---|---|---|---|---|---|---|
| std R | opcode val | ${r}_{4 - 0}^{d}$ | f₂₋₀ | ${r}_{4 - 0}^{s}$ | ${r}_{4 - 0}^{t}$ | k₆₋₀ |

The cskip and cnskip custom instructions are intended for conditional small jumps forward within a sequence of RISCV instructions that translate a single CISC instruction. A standard RISCV branch or jump instruction cannot be used in that context because it is configured with a target address created at compile time and which therefore can take into account of how many extra RISCV instructions have been inserted by the translation from CISC at runtime. The instructions respectively jump conditionally on the named register (usually the sfr flag register) being set, for cskip, or unset for cnskip. The RISCV S-format instructions are depicted below:

| | | | 7 | 5 | 3 | | | 5 | 5 | 7 |
|---|---|---|---|---|---|---|---|---|---|---|
| instruction | opcode name | form | opcode val | i₄₋₀ | ${r}_{5}^{s 1}$ | f₁ | ${r}_{5}^{s 2}$ | ${r}_{4 - 0}^{s 1}$ | ${r}_{4 - 0}^{s 2}$ | i₁₁₋₅ |
| cskip r^{s1}, i | CUST2_CNSKIP | S | 10_110_11 | iiiii | r | 0 | 0 | rrrrr | - - - - - | iiiiiii |
| | CUST2_CSKIP | S | 10_110_11 | iiiii | r | 1 | 0 | rrrrr | - - - - - | iiiiiii |

| | | | | | | |
|---|---|---|---|---|---|---|
| std S | opcode val | ${i}_{4 - 0}$ | f₂₋₀ | ${r}_{4 - 0}^{s 1}$ | ${r}_{4 - 0}^{s 2}$ | i₁₁₋₅ |

The custom prefix instruction is the only custom instruction for the embodiments that does not conform to the RISCV R/I/B/S/J instruction architectures listed in Table 2, but it is conformant as the last 2 bits of the RISCV 7 bit opcode field are not 11, which triggers non-standard decoding according to the RJSCV standard. The prefix instruction is to load 29 bits of immediate data into the accumulator register acc. It has one of four 5-bit opcodes, according to whether the first two bits of the data are 00, 01, 10 or 11, and the remaining lower 27 bits of data fill out the rest of the instruction as depicted below.

| | | | 7 | 25 |
|---|---|---|---|---|
| instruction | opcode name | form | opcode val | i₂₄₋₀ |
| prfx 00 | XXXX_PRFX0 | X | 1i_i01_00 | i_iiii_iiii_iiii_iiii_iiii_iiii |
| prfx 01 | XXXX_PRFX1 | X | 1i_i10_00 | i_iiii_iiii_iiii_iiii_iiii_iiii |
| prfx 10 | XXXX_PRFX2 | X | 1i_i01_10 | i_iiii_iiii_iiii_iiii_iiii_iiii |
| prfx 11 | XXXX_PRFX3 | X | 11_i10_11 | i_iiii_iiii_iiii_iiii_iiii_iiii |

The prfx(i) instruction loads the 29 bits of its immediate constant i into the upper portion of special register acc, leaving 12 zero bits at the bottom. The value acc that was in register acc—the bottom 12 bits were zero—is pushed up the register by the new insertion as follows:
acc←(acc<<29)|(i<<12)

The 29 bits pushed out of the top of register acc are pushed into the bottom of register acd, and the 29 bits pushed up out of the top of register acd are pushed into the bottom of register ace. This facilitates the translation of multiple 128-bit constants in a CISC instruction, as follows:

| | |
|---|---|
| prfx 0₁₁₋₀x₁₂₇₋₁₁₁ | # load upper part of constant x |
| prfx x₁₁₀₋₈₂ | # . |
| prfx x₈₁₋₅₃ | # . |
| prfx x₅₂₋₂₄ | # . |
| prfx x₂₃₋₀y₁₂₇₋₉₉ | # finish x, load upper part of y |
| prfx y₉₈₋₈₀ | # . |
| prfx y₇₉₋₄₁ | # . |
| prfx y₄₀₋₁₂ | # and start using immediate data: |
| addiw s, acc, y₁₁₋₀ | # complete loading y and add into s |
| addw r, r, acd | # add x to r |
| ... | |

The HGEN instruction generates a 96 bit hash from two 128 bit registers as input, placing it in the output register. The HPAD instruction mixes it into the input register and writes the combination into the output register as depicted below:

| | | | 7 | 5 | 3 | 5 | 5 | 7 | | | | |
|---|---|---|---|---|---|---|---|---|---|---|---|---|
| instruction | opcode name | form | opcode val | ${r}_{4 - 0}^{d}$ | f₂₋₀ | ${r}_{4 - 0}^{s 1}$ | ${r}_{4 - 0}^{s 2}$ | ${r}_{5}^{d}$ | f₅ | ${r}_{5}^{s 1}$ | ${r}_{5}^{s 2}$ | f₂₋₀ |
| hgen r^{d}, r^{s1}, r^{s2} | CUSTO_HGEN | R | 00_010_11 | rrrrr | 001 | rrrrr | rrrrr | r | 1 | r | r | 101 |
| hpad r^{d}, r^{s1}, r^{s2} | CUSTO_HPAD | R | 00_010_11 | rrrrr | 001 | rrrrr | rrrrr | r | 1 | r | r | 110 |
| | | std R | opcode val | ${r}_{4 - 0}^{d}$ | f₂₋₀ | ${r}_{4 - 0}^{s 1}$ | ${r}_{4 - 0}^{s 2}$ | f₆₋₀ | | | | |

The HPAD instruction is a convenience and could be replaced by RISCV128 instruction combinations. The action is to write the hash into the upper 96 bits of the target as follows:
r_{d}←rₛ_{₁} & 0xffffffff|rₛ_{₂} & ~0xffffffff

The remainder of the RISCV instructions needed for translation of CISC instructions are standard. However, for convenience some custom versions are implemented in order to more conveniently to access the upper 32 of the 64 general purpose registers. These extra custom instructions are not essential and are aimed at lowering instruction and cycle count for CISC instruction translation sequences. These instructions act arithmetically on the lower 32 bits of 128-bit register data. The top 96 bit hash is written in afterwards by a separate instruction.

No faults should ever be raised in the embodiments by arithmetic instructions on divide-by-zero or overflow or underflow, ideally a random result should be returned instead, but any result is valid for security. It will be masked by noise from the 96 bits of hash that is added to the result. It is necessary that an observer should not be able to tell that an interrupt has occurred. Interrupts should be masked at the start of each sequence translating a single CISC instruction, and reinstated, if at all, at the end. The standard RISCV instructions needed for CISC instruction translation and their formats are depicted in TABLE 10:

TABLE 10

| | | | 7 | 5 | 3 | 5 | 5 | 7 |
|---|---|---|---|---|---|---|---|---|
| instruction | opcode name | form | opcode val | ${r}_{4 - 0}^{d}$ | f₂₋₀ | ${r}_{4 - 0}^{s}$ | i₁₁₋₇ | i₆₋₀ |
| addiw r^{d}, r^{s}, i | OPIMM_ADDI | I | 00_100_11 | rrrrr | 000 | rrrrr | iiiii | iiiiiii |
| instruction | opcode name | form | opcode val | ${r}_{4 - 0}^{d}$ | f₂₋₀ | ${r}_{4 - 0}^{s}$ | ${r}_{4 - 0}^{t}$ | k₆₋₀ |
| addw r^{d}, r^{s1}, r^{s2} | OP_ADD | R | 01_100_11 | rrrrr | 000 | rrrrr | rrrrr | 0000000 |
| mulw r^{d}, r^{s1}, r^{s2} | OP_ MUL_MULDIV | R | 01_100_11 | rrrrr | 000 | rrrrr | rrrrr | 0000001 |
| subw r^{d}, r^{s1}, r^{s2} | OP_SUB | R | 01_100_11 | rrrrr | 000 | rrrrr | rrrrr | 0100000 |
| sllw r^{d}, r^{s1}, r^{s2} | OP_SLL | R | 01_100_11 | rrrrr | 001 | rrrrr | rrrrr | 0000000 |
| sltw r^{d}, r^{s1}, r^{s2} | OP_SLT | R | 01_100_11 | rrrrr | 010 | rrrrr | rrrrr | 0000000 |
| sltuw r^{d}, r^{s1}, r^{s2} | OP_SLTU | R | 01_100_11 | rrrrr | 011 | rrrrr | rrrrr | 0000000 |
| divw r^{d}, r^{s1}, r^{s2} | OP DIV_MULDIV | R | 01_100_11 | rrrrr | 100 | rrrrr | rrrrr | 0000001 |
| xorw r^{d}, r^{s1}, r^{s2} | OP_XOR | R | 01_100_11 | rrrrr | 100 | rrrrr | rrrrr | 0000000 |
| sraw r^{d}, r^{s1}, r^{s2} | OP_SRA | R | 01_100_11 | rrrrr | 101 | rrrrr | rrrrr | 0100000 |
| orw r^{d}, r^{s1}, r^{s2} | OP_OR | R | 01_100_11 | rrrrr | 110 | rrrrr | rrrrr | 0000000 |
| andw r^{d}, r^{s1}, r^{s2} | OP_AND | R | 01_100_11 | rrrrr | 111 | rrrrr | rrrrr | 0000000 |

The custom variants of the instructions listed in Table 10 are listed in Table 11. These have opcodes in the CUST regions of the standard opcode map. These custom instructions reference either the upper or lower 32 of 64 registers via their 5-bit register index field, depending as the corresponding bit in the function code is respectively set or unset as depicted in TABLE 11:

TABLE 11

| | | | 7 | 5 | 3 | | | 5 | 5 | 7 |
|---|---|---|---|---|---|---|---|---|---|---|
| instruction | opcode name | form | opcode val | ${r}_{4 - 0}^{d}$ | ${r}_{5}^{d}$ | f₁ | ${r}_{5}^{s}$ | ${r}_{4 - 0}^{s}$ | i₁₁₋₇ | i₆₋₀ |
| addiw r^{d}, r^{s}, i | CUST2_ADDI | I | 10_110_11 | rrrrr | r | 0 | r | rrrrr | iiiii | iiiiiii |

| | | std I | opcode val | ${r}_{4 - 0}^{d}$ | f₂₋₀ | ${r}_{4 - 0}^{s}$ | i₁₁₋₇ | i₆₋₀ | | | |
|---|---|---|---|---|---|---|---|---|---|---|---|
| instruction | opcode name | form | opcode val | ${r}_{4 - 0}^{d}$ | f₂₋₀ | ${r}_{4 - 0}^{s}$ | ${r}_{4 - 0}^{t}$ | ${r}_{5}^{d}$ | k₅ | ${r}_{5}^{s} {r}_{5}^{t}$ | k₂₋₀ |
| addw r^{d}, r^{s1}, r^{s2} | CUSTO_ADD | R | 00_010_11 | rrrrr | 000 | rrrrr | rrrrr | r | 0 | rr | 000 |
| subw r^{d}, r^{s1}, r^{s2} | CUSTO_SUB | R | 00_010_11 | rrrrr | 000 | rrrrr | rrrrr | r | 1 | rr | 101 |
| sltw r^{d}, r^{s1}, r^{s2} | CUSTO_SLT | R | 00_010_11 | rrrrr | 010 | rrrrr | rrrrr | r | 1 | rr | 110 |
| sltuw r^{d}, r^{s1}, r^{s2} | CUSTO_SLTU | R | 00_010_11 | rrrrr | 011 | rrrrr | rrrrr | r | 1 | rr | 111 |

| | | | | | | |
|---|---|---|---|---|---|---|
| std R | opcode val | ${r}_{4 - 0}^{d}$ | f₂₋₀ | ${r}_{4 - 0}^{s}$ | ${r}_{4 - 0}^{t}$ | k₆₋₀ |

As noted above, the ‘w’ suffix on the arithmetic instruction names indicates these are arithmetically 32-bit operations.

There are two standard RISCV B-format branch instructions used in CISC instruction translation sequences depicted below:

| | | | 7 | 5 | 3 | 5 | 5 | 7 |
|---|---|---|---|---|---|---|---|---|
| instruction | opcode name | form | opcode val | i₁₀i₃₋₀ | f₂₋₀ | ${r}_{4 - 0}^{s 2}$ | ${r}_{4 - 0}^{s 1}$ | i₉₋₄i₁₁ |
| beqw r^{d}, r^{s1}, i | BRANCH_BEQ | B | 11_000_11 | iiiii | 000 | rrrrr | rrrrr | iiiiiii |
| bnew r^{d}, r^{s1}, i | BRANCH_BNE | B | 11_000_11 | iiiii | 001 | rrrrr | rrrrr | iiiiiii |

The jump distance in the branch instruction is relative to the original CISC instruction, which is not meaningful after translation from the CISC instruction to a sequence of RISCV instructions as the number of intermediate RISC instructions generated between the branch instruction and the intended target instruction is not known and the current PC points to a virtual program address space that bears little relation to the original CISC instruction addresses. The branch instruction has only one use in the generated translation sequences, and that is to abort the rest of the current sequence with beqw r,s,0 or bnew r,s,0. That zero jump is executed as a change of PC within the generated RISCV instruction address space to point to the start of the translation sequence for the next CISC instruction. The DTU has one input port for a signal indicating a jump in the CISC instruction address space, and another port for signals indicating a jump in the generated RISC instruction address space. The cskip/cnskip (see earlier section) instructions are used instead for jumps forward within a single translation sequence in the generated RISCV instruction address space, and they can also be used instead of a branch 0 instruction to jump to the end of the current translation sequence.

A jump to a CISC instruction address utilizes the jalr instruction with the format as shown below:

| | | | 7 | 5 | 3 | 5 | 5 | 7 |
|---|---|---|---|---|---|---|---|---|
| instruction | opcode name | form | opcode val | ${r}_{4 - 0}^{d}$ | f₂₋₀ | ${r}_{4 - 0}^{s}$ | i₁₁₋₇ | i₆₋₀ |
| jalr r^{d}, r^{s}, i | JALR | I | 11_001_11 | rrrrr | 000 | rrrrr | iiiii | iiiiiii |

Additionally, translation sequences employ custom versions of this instruction with opcodes in the CUST region of the standard map that can access the full range of 64 general purpose registers. The format is shown below:

| | | | 7 | 5 | 3 | | | 5 | 5 | 7 |
|---|---|---|---|---|---|---|---|---|---|---|
| instruction | opcode name | form | opcode val | ${r}_{4 - 0}^{d}$ | ${r}_{5}^{d}$ | f₁ | ${r}_{5}^{s}$ | ${r}_{4 - 0}^{s}$ | i₁₁₋₇ | i₆₋₀ |
| jalr r^{d}, r^{s}, i | CUST3_JALR | I | 11_110_11 | rrrrr | r | 0 | r | rrrrr | iiiii | iiiiiii |

| | | | | | | |
|---|---|---|---|---|---|---|
| std I | opcode val | ${r}_{4 - 0}^{d}$ | f₂₋₀ | ${r}_{4 - 0}^{s}$ | i₁₁₋₇ | i₆₋₀ |

The jump effected by jalr r,s,i is to the CISC instruction with address in register s plus offset i, and the current CISC instruction address a plus 1 word is stored in register r. To branch to a CISC instruction using a relative jump, translation takes the current CISC instruction address a and the increment i, and explicitly writes the target CISC instruction address a+1+i as an offset from the zero register in a jalr instruction in a RISCV two-instruction sequence as follows:
cnskip sfr,1
jalr t,zer, a+1+i

If the flag register sfr is nonzero above, then execution drops through the cnskip into the jump. The target register t is for discarding the return address to, it could be illr. That sequence works if a+1+i does not overflow 12 bits, i.e., it lies on page zero of program memory, and if it is larger then a prefix instruction must be used and the jump is relative to the prefix accumulator register as shown below:
cnskip(sfr,2)
prfx [a+1+i]₃₁₋₁₂
jalr t, acc, [a+1+i]₁₁₋₀

The prefix instruction in the sequence above leaves a 12-bit space at the low end of the accumulator register acc and the 12-bit immediate in the jump instruction fits into it to recreate the 32-bit target address. Up to a 41-bit address is theoretically attainable from that code sequence. With more prefixes 128-bit addresses are may be specified.

In order to translate the CISC instruction for return from interrupt (C.rfe), the standard RISCV sret( ) instruction is used, with opcode SYSTEM SRET. The instruction runs in supervisor mode and changes mode to user mode. It reads the saved PC in the EPCR register and jumps back to that program address, and it also reads the saved user status flags in the ESR register and restores them. A CISC software interrupt call instruction is translated by the standard RISCV ecall(r,s) instruction, with opcode SYS-TEM PRIV ECALL. Which registers are used for return and argument is implementation dependent. The formats of the (standard RISCV) ecall and sret instructions are shown below:

| instruction | opcode name | form | opcode val | ${r}_{4 - 0}^{d}$ | f₂₋₀ | ${r}_{4 - 0}^{s}$ | i₁₁₋₀ |
|---|---|---|---|---|---|---|---|
| ecall r^{d}, r^{s}, i | SYSTEM_PRIV_ECALL | I | 11_100_11 | rrrrr | 000 | rrrrr | 00000_000 0000 |
| sret | SYSTEM_SRET | I | 11_100_11 | - - - - - | 000 | - - - - - | 0 001 0_000 1000 |

The sret instruction runs in supervisor mode, and the ecall instruction runs both in user mode and supervisor mode.

Some system functions are implemented via reads from and writes to high register indices. In order to translate the CISC C.mfspr and C.mtspr instructions to RISCV sequences the standard RISCV csrrw(s,r,h) and csrrc(r,s,h) instructions are utilized. They respectively write data from/to register r to/from a system register/configuration status register (CSR) s, using a 12-bit index. These are I-format instructions. RISCV specifies that CSSRW may swap out the CSR content to a second register indexed in the instruction, but that option is not needed in translation to RISCV instruction sequences and the field will always be 0. A similar field in the csrrc instruction specifies a register containing a bitmask for bits to clear in the CSR being read, and that is not needed for translations and that field will always 0. The cssrwi instruction is a variant of the cssrw instruction that interprets the cssrw source register index field instead as a 5-bit immediate constant, zero-filled for writing to the target CSR. The formats of those standard RISCV csrr* instructions are shown below:

| | | | 7 | 5 | 3 | 5 | 12 |
|---|---|---|---|---|---|---|---|
| instruction | opcode name | form | opcode val | - - - - - | f₂₋₀ | ${r}_{4 - 0}^{s}$ | ${s}_{11 - 0}^{d}$ |
| csrrw 0, r^{s}, s^{d} | SYSTEM_CSRRW | I | 11_100_11 | 00000 | 001 | rrrrr | SSSSSSSSSSSS |
| csrrwi 0, k, s^{d} | SYSTEM_CSRRWI | I | 11_100_11 | 00000 | 101 | kkkkk | SSSSSSSSSSSS |
| instruction | opcode name | form | opcode val | ${r}_{4 - 0}^{d}$ | f₂₋₀ | - - - - - | ${s}_{11 - 0}^{s}$ |
| csrrc r^{d}, 0, s^{s} | SYSTEM_CSRRC | I | 11_100_11 | rrrrr | 011 | 00000 | SSSSSSSSSSSS |

The standard RISCV csrr* instructions described above will work only in supervisor mode, as access to CSRs is restricted on RISCV platforms. The DTU operates in supervisor mode as well as in user mode, differing only in the encryption/decryption instructions are no-ops with reference to paragraph 33. A typical use is with the immucr and dmmucr system registers as targets in order to create entries in the page address map for user mode, just prior to a switch to user mode.

There are also custom RISCV versions of the above instructions that reference the upper 32 general purpose registers instead of the lower 32. Their opcodes lie in the CUST range of the RISCV standard opcode map of Table 1. The formats are shown below:

| | | | 7 | 5 | 3 | 5 | 12 |
|---|---|---|---|---|---|---|---|
| instruction | opcode name | form | opcode val | - - - - - | f₂₋₀ | ${r}_{4 - 0}^{s}$ | ${s}_{11 - 0}^{d}$ |
| csrrw 0, r^{s}, s^{d} | CUST2_CSRRW | I | 10_110_11 | 00000 | 000 | rrrrr | SSSSSSSSSSSS |
| instruction | opcode name | form | opcode val | ${r}_{4 - 0}^{d}$ | f₂₋₀ | - - - - - | ${s}_{11 - 0}^{d}$ |
| csrrc r^{d}, 0, s^{s} | CUST3_CSRRC | I | 11_110_11 | rrrrr | 011 | 00000 | SSSSSSSSSSSS |

The CISC machine code language that the DTU translates into RASCV instructions for internal running is a small generic RISC instruction set with 128-bit immediate constants, at least one in every instruction that does arithmetic. In consequence, a CISC instruction can be very long, as much as 16 or more (32-bit) words. It is consistently organized as follows: A CISC instruction consists of prefix words supplying immediate constants to the instruction, followed by a final word that specifies the operation to be carried out and its source and target registers if any. The register index fields are 5 bits wide, referencing 32 user-programmable general purpose registers. Each appears 32 bits wide to the programmer but physically the 32-bit data is encoded as 128-bits encrypting the 32 bits of data plus 96 bits of statistically random padding.

CISC arithmetic instructions always include one or more 128-bit encrypted immediate con-stants. The C.add r,s,t,k′ instruction, for example, incorporates exactly one: k′. The following is the breakdown of the instruction into five 32-bit words, in increasing byte address order from byte a+0 to a+19 inclusive. The address of the whole instruction is a and it is 20 bytes long. The prefix instruction containing the most significant bits of the encrypted constant k′ comes first:

| | |
|---|---|
| a+0: | C.prf k′₁₂₇₋₉₉ |
| a+4: | C.prf k′₉₈₋₇₀ |
| a+8: | C.prf k′₆₉₋₄₁ |
| a+12: | C.prf k′₄₀₋₁₂ |
| a+16: | C.add r, s, t, k′₁₁₋₀ |

The 128-bit immediate constant k′ carried by the prefixes is the 128-bit encryption of a 32-bit constant k. That sequence performs the following operation on the plaintext values hidden by the encryption:
r←s+t+k

Plantext values r, s, t are encoded as padded and encrypted values in registers r, s and t, respectively.

The final add r^{d}, r^{s1}, r^{s2}, k′ instruction word's format is shown below:

| | 5 | 5 | 5 | 5 | 12 |
|---|---|---|---|---|---|
| instruction | C.ADD | r^{d} | r^{s}^{₁} | r^{s}^{₂} | k′ |
| C.add r^{d}, r^{s1}, r^{s2}, k | 00001 | rrrrr | rrrrr | rrrrr | kkkk_kkkk_kkkk |

CISC arithmetic instructions that take two arguments and produce a result all have this same architecture. That is a 5-bit major opcode, three 5-bit register fields, then a 12-bit immediate (that will be the final 12 bits of a 128-bit immediate the rest of which has been supplied by preceding prefix words). Below is the complete list of CISC arithmetic instruction opcodes:

| opcode name | C. ADD | C. SUB | C. MUL | C. DIV | C. SRA | C. SLL | C. XOR | C. AND | C. OR |
|---|---|---|---|---|---|---|---|---|---|
| opcode val | 00001 | 00010 | 00011 | 00100 | 00101 | 11000 | 10101 | 10110 | 10111 |

Prefix words have the 3-bit binary opcode 111, followed by 29 bits of data as depicted below:

| | 3 | 29 |
|---|---|---|
| instruction | C.PRF | k |
| C.prf k | 111 | k_kkkk_kkkk_kkkk_kkkk_kkkk_kkkk_kkkk |

No other CISC binary opcode begins 111.

Add and subtract are the only arithmetic CISC instructions that take just one immediate constant. The rest have two or three, requiring respectively 5+4 or 5+5+4 prefix words each. The CISC arithmetic instructions all follow the same pattern in terms of their functionality. For example, for multiplication C.mul r s t a′b′c′, where the encrypted 128-bit immediate constants a′, b′, c′ encode the 32-bit values a, b, c respectively, and r, s, t are respectively the plaintext data values encodes and encrypted in registers r, s, t, the functionality is as follows:
r←(s+b)*(t+c)−α

The pattern above consists of one immediate constant added to each of the arguments and one subtracted from the result. The CISC machine code language contains the full complement of CISC comparator instructions, less than, greater than, less than or equal to, greater than or equal to, in signed and unsigned versions, as well as equals and not equals. Each sets a flag on success and unsets it on failure. Signed comparison instructions have one immediate constant, unsigned comparisons have two. For example, the functionality of the signed less-than comparison is as follows:
flag←r<s+k
   while the functionality of the unsigned less-than comparison is as follows:
flag←r+a<s+b

The CISC comparator instructions have two (5-bit) register index fields and a 10-bit opcode. The format for the C.sfltu instruction (unsigned less than) is shown below and contains the 12 least significant bits of a padded and encrypted immediate constant, the rest of its 128-but encryption being supplied in the prefix words as depicted below:

| | 10 | 5 | 5 | 12 |
|---|---|---|---|---|
| instruction | C.SFLTU | r^{s}_{¹} | r^{s}_{²} | k |
| C.sfltu(r^{s1}, r^{s2}, k) | 00111_00110 | rrrrr | rrrrr | kkkk_kkkk_kkkk |

The list of opcodes of the comparator instructions is shown below. Each is 10 bits long and begins with the 5-bit code 00111:

| | C. SFLT | C. SFGT | C. SFLE | C. SFGE | C. SFEQ | C. SFNE |
|---|---|---|---|---|---|---|
| 00111 | 00000 | 00001 | 00010 | 00011 | 00100 | 00101 |

| | C. SFLTU | C. SFGTU | C. SFLEU | C. SFGEU |
|---|---|---|---|---|
| 00111 | 00110 | 00111 | 01000 | 01001 |

The CISC machine code language contains three single-word branch instructions, two conditional and one unconditional. The C.bf k and C.bnf k instructions respectively jump ahead by k when the flag is set and when it is not set. The C.b k instruction jumps unconditionally. The opcode is 12 bits long, beginning with the five bits 01101, and the address increment k is 20 bits long. The format of the CISC branch instruction is shown below.

| | 5 | 7 | 20 |
|---|---|---|---|
| C.bf k | 01101 | 0000000 | kkkk_kkkk_kkkk_kkkk_kkkk |
| C.bnf k | 01101 | 1000001 | kkkk_kkkk_kkkk_kkkk_kkkk |
| C.b k | 01101 | 1100001 | kkkk_kkkk_kkkk_kkkk_kkkk |

There are two single-word jump instructions that jump to a fixed target address k, C.jal k and C.j k, for 26-bit addresses k, with a 6-bit opcode, as well as a return from subroutine instruction C.ret. The format of the CISC jump instructions is shown below:

| | 5 | 1 | 26 |
|---|---|---|---|
| C.jal k | 10100 | 0 | kk_kkkk_kkkk_kkkk_kkkk_kkkk_kkkk |
| C.j k | 10100 | 1 | kk_kkkk_kkkk_kkkk_kkkk_kkkk_kkkk |
| C.ret | 01101 | 0 | 00_0000_0000_0000_0000_0000_0000 |

The instruction C.jal k is used to call a subroutine at address k. That puts the next instruction address as the return address in the (hidden) return address register Ink. A C.ret instruction at the end of the subroutine restores the program counter from that register. The nth software interrupt handler is called with the C.sys n instruction, which will jump to the nth in a fixed vector of handlers on memory page zero and change to supervisor mode. Return from the handler to user mode is via the single-word C.rfe instruction as depicted below:

| | 5 | 11 | 16 |
|---|---|---|---|
| C.sys n | 01101 | 110_0010_0000 | nnnn_nnnn_nnnn_nnnn |
| C.rfe | 01101 | 110_0011_0000 | 0000_0000_0000_0000 |

The CISC machine code language allows for memory access via two multi-word instructions. The C.lw r,k′[s] instruction writes to register r from the address in register s plus an offset by k, and the C.sw [k]r,s instruction reads from register s to the address in register r plus an offset k. Prefix words supply all but 12 bits of the 128-bit encrypted offset k′, the final 12 bits are part of the instruction word which has the following form shown below:

| | 5 | 5 | 5 | 5 | 12 |
|---|---|---|---|---|---|
| C.lw r^{d}, k′₁₁₋₀[r^{s}] | 10001 | rrrrr | rrrrr | 00000 | kkkk_kkkk_kkkk |
| C.sw k′₁₁₋₀[r^{s1}], r^{s2} | 10000 | rrrrr | rrrrr | 00000 | kkkk_kkkk_kkkk |

The memory barrier instruction in the CISC machine code language is the single-word instruction C.msync( ) which forces writes through to memory (i.e., holds off further writes until existing writes have finished). The pipeline barrier instruction is the single-word instruction C.psync( ) which asserts data dependencies such that instructions behind in the pipeline cannot progress until it exits. The formats are shown below:

| | 5 | 11 | 16 |
|---|---|---|---|
| C.msync | 01101 | 110_0100_0000 | 0000_0000_0000_0000 |
| C.psync | 01101 | 110_0101_0000 | 0000_0000_0000_0000 |

The CISC machine code language has a single-word conditional move instruction C.cmov r,s,t that if the flag is set copies content of register s to r, while if it is unset then it copies the content of register t to r. Also a single-word instruction C.xchg r,s that swaps the contents of registers r and s, and an instruction C.nop k that does nothing. The formats of those instructions are shown below:

| | 5 | 11 | 1 | 5 | 5 | 5 |
|---|---|---|---|---|---|---|
| C.cmov r^{d}, r^{s1}, r^{s2} | 01101 | 100_0000_1000 | 0 | rrrrr | rrrrr | rrrrr |
| C.xchg r^{d}, r^{s} | 01101 | 110_0000_0000 | 0 | rrrrr | rrrrr | 00000 |
| C.nop k | 00000 | 000_0000_0000 | k | kkkkk | kkkkk | kkkkk |

The CISC machine code language contains four instructions that move data between the 32 general purpose registers and so-called ‘system registers’, which are represented by 16-bit indices. The C.mfspr r,s instruction reads from the system register with index s to general register r, while C.mtspr s,r writes to system register s from general register r. The C.xfspr r,s and C.xtspr s,r instructions both swap contents of general register r and system register s. The format of those instructions are shown below:

| | 5 | 5 | 1 | 5 | 16 |
|---|---|---|---|---|---|
| C.mtspr s^{d}, r^{s} | 00111 | 10000 | 0 | rrrrr | ssss_ssss_ssss_ssss |
| C.mfspr r^{d}, s^{s} | 00111 | 10001 | 0 | rrrrr | ssss_ssss_ssss_ssss |
| C.xtspr s^{d}, r^{s} | 00111 | 10010 | 0 | rrrrr | ssss_ssss_ssss_ssss |
| C.xfspr r^{d}, s^{s} | 00111 | 10011 | 0 | rrrrr | ssss_ssss_ssss_ssss |

This CISC machine code language is intended to be minimalist and computationally complete. With respect to cryptological security, all programs can be changed via the immediate constants in every arithmetic instruction to modify the plaintext value beneath the encryption in registers and memory at every point in the program, statistically independently from each other over the complete range of 32-bit values and with no statistical bias. That guarantees it is no less secure in a cryptological sense (‘semantic security’) than the encryption itself. In other words, encrypted computing with this CISC instruction set and a ‘chaotic’ compiler that provides statistically random variation for each recompilation does not compromise encryption.

A dynamic translation unit (DTU) translates each 32-bit word of a CISC binary machine code instruction to a sequence of RISCV binary machine codes. The translated sequences exist in a virtual program address space and the program counter (PC) of the processor points into the virtual address space. The DTU is positioned between the fetch stage and the instruction memory manager unit (iMMU), and the DTU provides non-virtual instruction address to the iMMU which reference locations in memory. The iMMU lay then remap those (‘logical’) instruction addresses to (‘physical’) locations in RAM or other storage. The following section describes the CISC to RISCV instruction translations.

The translation of prefix words takes each CISC C.prf k instruction to the RISCV instruction prfx k, where k is a 29-bit fragment of a 128-bit immediate constant. The RISCV instruction loads the accumulator register acc with the fragment as discussed in paragraph 43.

Translation of CISC Arithmetic Instruction with One 128-Bit Immediate

Translation generally takes one CISC instruction to many more than one RISCV instruction. The simplest nontrivial case is that of the CISC C.add r,s,t,k′₁₁₋₀ instruction word, which includes the final 12-bit portion

$${k}_{11 - 0}^{′}$$

of a 128-bit encrypted constant k′ as its immediate. The prefixes that supplied the upper 116 bits will have been translated to the custom RISCV prefixes that load the upper 116 bits of k′ into the accumulator register acc. Translation generates a sequence of 11-0 RISCV instructions that loads the 12-bit immediate into the bottom 12 bits of the accumulator register, decrypts the accumulated constant, then adds the decrypted value to that in register s and that into register t into register r. (The translation is such that that unencrypted values reside in those registers at this point at runtime.)

Explicitly, the translation sequence generated first adds registers s and t into r, then loads the 12-bit rump of k′ into acc and decrypts it into the upper-32 register t8 as follows:

| | |
|---|---|
| prfx k′₁₂₇₋₉₉ | # previously translated prefix |
| prfx k′₉₈₋₇₀ | # previously translated prefix |
| prfx k′₆₉₋₄₁ | # previously translated prefix |
| prfx k′_{40- 12} | # previously translated prefix |
| addw r, s, t | # get register addition done |
| decr1i t1, acc, k′₁₁₋₀ | # load rump and start decryption |
| ... | |
| decrA t1, t1 | # finish decryption of k |
| addw r, r, t1 | # add k into r |

That translation omits to check with the crypto cache for the decryption before decrypting. Including such a check in the sequence gives the following translation of the CISC C.add r,s,t,k′ instruction word:

| | |
|---|---|
| addw r, s, t | # get register addition done |
| getkdi t1, acc, k′₁₁₋₀ | # load rump and check cache |
| cskip sfr, 11 | # if decryption cached, skip decryption |
| decr1i t1, acc, k′₁₁₋₀ | # load rump and start decryption |
| ... | |
| decrA t1, t1 | # finish decryption of k |
| putkdi t1, acc, k′₁₁₋₀ | # cache any explicit decryption |
| addw r, r, t1 | # add k into r |

This sequence is 15 RISCV words long. The translation for the C.CISCsub r,s,t,k instruction word is the same but for the initial addw r,s,t in the translation above, which is replaced by subw r,s,t.
Translation of CISC Arithmetic Instruction with Two 128-Bit Immediates

A CISC instruction that takes two immediate encrypted constants a′ and b′ is translated ås follows. These include the unsigned comparator instructions, which add constants to both sides of the comparison and set or unset the flag according to success or failure of the comparison. The immediates a′ and b′ will have been supplied via prefixes, all except for the last 12 bits of a′, which will be supplied in the last 32-bit word of the CISC instruction. That may be, for example, C.sfltu r, s, a′ The translation for that is described below.

The sequence starts with instructions that load the encrypted constant b′, into accumulator acd, and the upper 116 bits of a′ into the upper 116 bits of accumulator acc.

The instructions generated to translate the C.sfltu r, s,

$${a}_{11 - 0}^{′}$$

instruction word, first decrypts a′, b′ are, then adds them to the contents of registers r and s respectively, then the results are compared. The sequence of RISCV instructions translating the final C.sfltu r, s, a′₁₁₋₀ is as follows:

| | |
|---|---|
| getkdi t1, acc, a′₁₁₋₀ | # decrypt a′ to a in t1 |
| cskip sfr, 11 | # . |
| decr1i t1, acc, a′₁₁₋₀ | # . |
| ... | |
| decrA t1, t1 | # . |
| putkdi t1, acc, a′₁₁₋₀ | # . |
| getkd t2, acd | # decrypt b′ to b in t2 |
| cskip sfr, 11 | # . |
| decr1 t2, acd | # . |
| ... | |
| decrA t2, t2 | # . |
| putkd t2, acd | # . |
| addw t1, r, t1 | # add a to r into t1 |
| addw t2, s, t2 | # add b to s into t2 |
| sltuw sfr, t1, t2 | # compare r+a with s+b |

This translation sequence is 29 RISCV instructions long.
Translation of CISC Arithmetic Instruction with Three 128-Bit Immediates

CISC arithmetic instructions other than addition and subtraction, such as multiplication take three 128-bit encrypted constants, a′, b′ and c′. The translation supplies those a sequence of custom RISCV prefix instructions each translating a CISC prefix word. The final CISC instruction word C.mul r,s,t,a′ contains the last 12 bits of the encrypted constant a′. The translation of the latter instruction word is a sequence of RISCV instructions that first decrypts the two encrypted constants a′ and b′ and then adds the decrypted values to the contents of the registers r and s, as for the unsigned less-than comparator above. The third encrypted constant, c′, is then decrypted and the decrypted value is subtracted from the multiplication result. Thus the translation of C.mul r, s, t, a′₁₁₋₀ is the same as that for C.sltu above, except that instead of the final sfltu(sfr,t8,t9) RISCV instruction in the translation sequence, there is the following sequence of RISCV instructions:

| | |
|---|---|
| ... | |
| mulw t, r, s | # (was sltuw) |
| getkd t3, ace | # decrypt c′ to c in t3 |
| cskip sfr, 11 | # . |
| decr1 t3, ace | # . |
| ... | |
| decrA t3, t3 | # . |
| putkd t3, ace | # . |
| subw t, t, t3 | # subtract c from (r+a)*(s+b) |

That is a total of 43 RISCV instructions in the translation sequence for CISC instruction word C.mul t,r,s,a′. However, if there are three crypto cache hits in that sequence at runtime, only 10 of those will be executed.

### Translation of CISC Memory Access Instructions

The CISC load from memory instruction expects an unencrypted program address in register s and decrypts an encrypted constant k′ to k and adds it to the content of register s forming the address s+k, then encrypt it. That encrypted address will then be utilized as described below.

Prefix instructions will already have loaded the 116 high bits of encrypted constant k′ into register acc, at this point at runtime, and an unencrypted value will be in register s. The RISCV instruction sequence generated by the DTU to translate the CISC C.1d r, k′₁₁₋₀ [s] instruction word loads the final 12 bits and decrypts k′ to k then adds it to s to get s+k, and then encrypts that to a 128-bit encrypted address. The sequence continues with a call to the TLB unit with the custom RISCV seta instruction. That replaces the encrypted 128-bit address with a unique 32-bit address. The 32 bit address obtained from the TLB is used for the retrieval from memory of the data. The data has been stored encrypted and the instruction sequence finishes by decrypting it into register r. The generated sequence of RISCV instructions is as follows:

| | |
|---|---|
| getkdi t1, acc, k′₁₁₋₀ | # decrypt k′ to k in t1 ... |
| cskip sfr, 11 | # . |
| decr1i t1, acc, k′₁₁₋₀ | # . |
| ... | |
| decrA t1, t1 | # . |
| putkdi t1, acc, k′₁₁₋₀ | # . |
| addw t1, s, t1 | # sum k with s into t1 |
| getke t2, t1 | # encrypt sum into t2 ... |
| cskip sfr, 11 | # . |
| encr1 t2, t1 | # . |
| ... | |
| encrA t2, t1 | # . |
| putke t2, t1 | # . |
| seta t2 | # replace encrypted sum with 32b location |
| get t3, t2 | # read from memory at location |
| getkd r, t3 | # decrypt read value into r... |
| cskip sfr, 11 | # . |
| decr1 r, t3 | # . |
| ... | |
| decrA r, r | # . |
| putkd r, t3 | # . |

That is a length 42 RISCV instruction sequence, but with three cache hits at runtime only 9 of those instructions will be executed. Since program addresses are stored unencrypted not encrypted in memory, retrieving a program address as opposed to program data requires a translation sequence of RISCV instructions that omits the final decryption sequence above, for 31 instructions total. Storing data to memory with the C.st [k′] r, s instruction word requires a reverse sequence of RISCV instructions as its translation. Prefix instructions will at runtime at this point have loaded the top 116 bits of encrypted constant k′ into register acc. The sequence of RISCV instructions may expect decrypted values in registers r and s. The instruction sequence first completes the loading of the last 12 bits of k′ and then decrypts k′ to k. It then encrypts r+k to get a 128-bit encrypted address. That 128-bit address is then substituted via a call to the TLB unit with the custom RISCV seta instruction by a 32-bit address. The data in register s is then encrypted before storing it in memory at that address. The sequence of custom RISCV instructions is as follows:

| | |
|---|---|
| getkdi t1, acc, k′₁₁₋₀ | # decrypt k′ to k in t1 ... |
| cskip sfr, 11 | # . |
| decrli t1, acc, k₁₁₋₀ | # . |
| ... | |
| decrA t1, t1 | # . |
| putkdi t1, acc, k₁₁₋₀ | # . |
| addw t1, r, t1 | # sum k with s into t1 |
| getke t2, t1 | # encrypt sum into t2 ... |
| cskip sfr, 11 | # . |
| encr1 t2, t1 | # . |
| ... | |
| encrA t2, t2 | # . |
| seta t1 | # replace encrypted sum with 32b location |
| getke t3, s | # encrypt value to write into t3 ... |
| cskip sfr, 11 | # . |
| encr1 t3, s | # . |
| ... | |
| encrA t3, t3 | # . |
| putke t3, s | # . |
| put t1, t3 | # write encrypted value at location |

That sequence of RISCV instructions is 42 long. To store a program address (unencrypted) instead of data (encrypted) in memory, the final subsequence that encrypts the value to be written is elided.

Translation of CISC Call and Return from Subroutine

The single word CISC instruction C.jal b is used to call the subroutine residing at instruction address b, placing the addressed fit a of the next CISC instruction in a return address register. Provided both addressed fit in 12 bits, i.e., are on the first page of memory, the DTU translates the instruction to the two RISCV instructions below. Here illr that one of the upper 32 of 64 registers that no instruction reads and xer is that upper 32 register that no instruction writes and which always contains a zero value.

| | |
|---|---|
| addiw lnk, xer, a₁₁₋₀ | # store next address a in lnk |
| jalr ill, xer, b₁₁₋₀ | # jump to address b |

The addiw instruction above is used as a convenient way of loading a short immediate into a target register. The usage above writes into the Ink register the next instruction address a in the virtual address space of RISCV instructions that program counter (PC) points into and causes the processor to jump to the address b in the CISC instruction address space, resetting the PC to b. At that point at runtime, CISC and the virtual RISCV instruction address spaces will have been resynchronize. The Ink register is not directly accessible to the CISC programmer, being one of the upper 32 of the 64 general purpose registers in the embodiments.

If either address a, b above does not fit in 12 bits, then the translation to RISCV instructions uses prefixes. The general case for 32-bit addresses a, b uses the four-instruction sequence below:

| | |
|---|---|
| prfx 0₈₋₀a₃₁₋₁₂ | |
| addiw lnk, acc, a₁₁₋₀ | # store next address a in lnk |
| prfx 0₈₋₀b₃₁₋₁₂ | |
| jalr ill, acc, b₁₁₋₀ | # jump to address b |

If only one of a, b is longer than 12 bits, then only one extra prefix instruction is required, not two. Note that jalr r,s,k instruction adds b₁₁₋₀ to the top bits b₃₁₋₁₂ shifted up by 12 bits that already occupies register acc, forming the complete address b before jumping to it. The translation of the CISC single-word C.ret instruction that effects a return from a function call is the following single RISCV instruction:
jalr illr, Ink, 0

It jumps to the return address stored in the Ink register that has been placed there by a call to a subroutine or has been restored to the register from memory. The illr register is never read by any instruction, so writing to it causes no delays because of data dependencies with respect to other instructions in the processor pipeline.

### Translation of CISC Jump

The translation of a CISC jump instruction C.j a which causes the processor to jump to address a, is a single RISCV instruction, provided address a fits in 12 bits as follows:
jalr illr, xer, a₁₁₋₀ #jump to address a
   For a 32-bit address a the translation includes a prefix instruction as follows:

| | |
|---|---|
| prfx 0₈₋₀a₃₁₋₁₂ | |
| jalr ill, acc, a₁₁₋₀ | # jump to address a |

The illr register is never read, so there are no pipeline dependency delays caused by the RISCV jalr instruction writing to it.

### Translation of Miscellaneous CISC Register-Register Instructions

The CISC conditional move instruction C.cmov r,s₁,s₂ is translated to the single custom RISCV instruction cmov r,s₁,s₂, since those CISC instructions that set the flag will have been translated to RISCV sequences that set the sfr register, which is consulted by the custom RISCV cmov instruction. The CISC swap register instruction C.xchg r,s is translated to the following short sequence

| | | |
|---|---|---|
| mov | t8, | r |
| mov | r, | s |
| mov | s, | t8 |

The t8 register is one of the upper 32 general purpose registers.

The CISC no-op instruction C.nop k, where k is a short integer datum, translates to any RISCV instruction with null effect. The DTU generates ori illr,xer,k as no instruction can write to the xer register and no instruction will read from the illr register, so there can be no data dependency to block its progress in the processor pipeline.

Translation of CISC Instructions that Access System Registers

The CISC C.mtspr s,r instruction is translated to the single RISCV instruction cssrw 0, r, s. The C.mfspr r,s instruction is translated to the single RISCV instruction mfspr r,s. The CISC C.xtspr s,r instruction, which swaps contents between special register s and general register r, is translated to the single instruction csrrw r, r, s. The C.xfspr r, s instruction is translated to that too.

Translation of CISC Instructions to Call and Return from System Functions

The CISC instruction C.sys k, where k is a short integer, is translated to the following RISCV instruction sequence:
addi s, xer, k;
ecall r, s

Here the registers r, s are those designated for argument and return value for the kth system call. The CISC C.rfe instruction that ends a software or hardware interrupt handler is translated to the standard RISCV instruction sret.

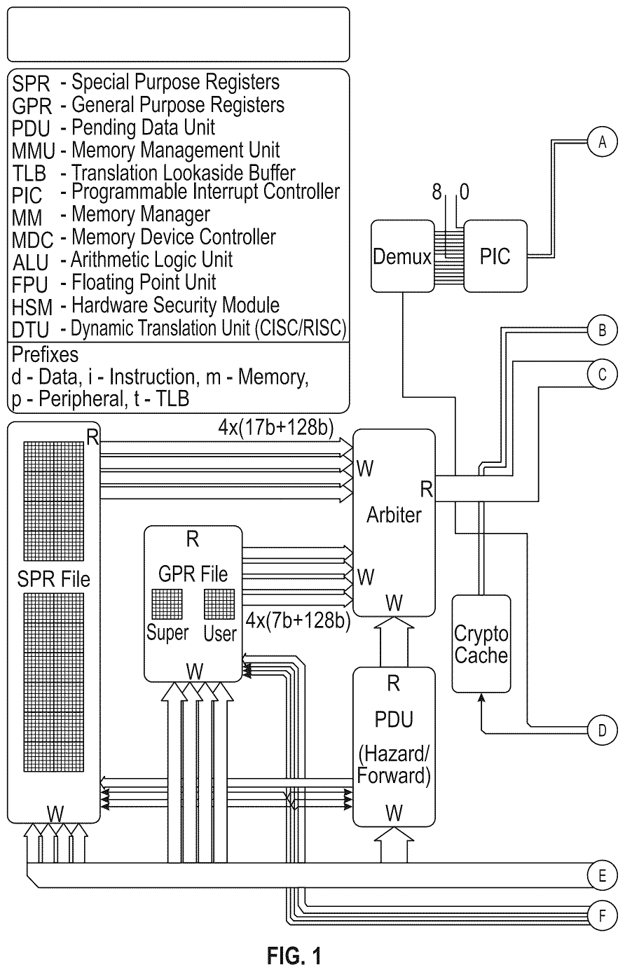

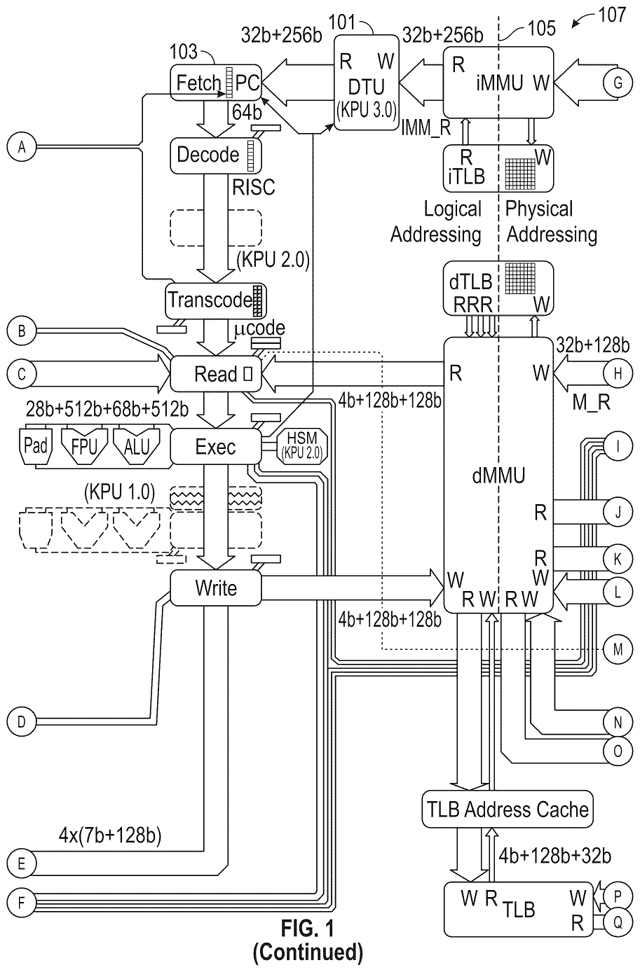

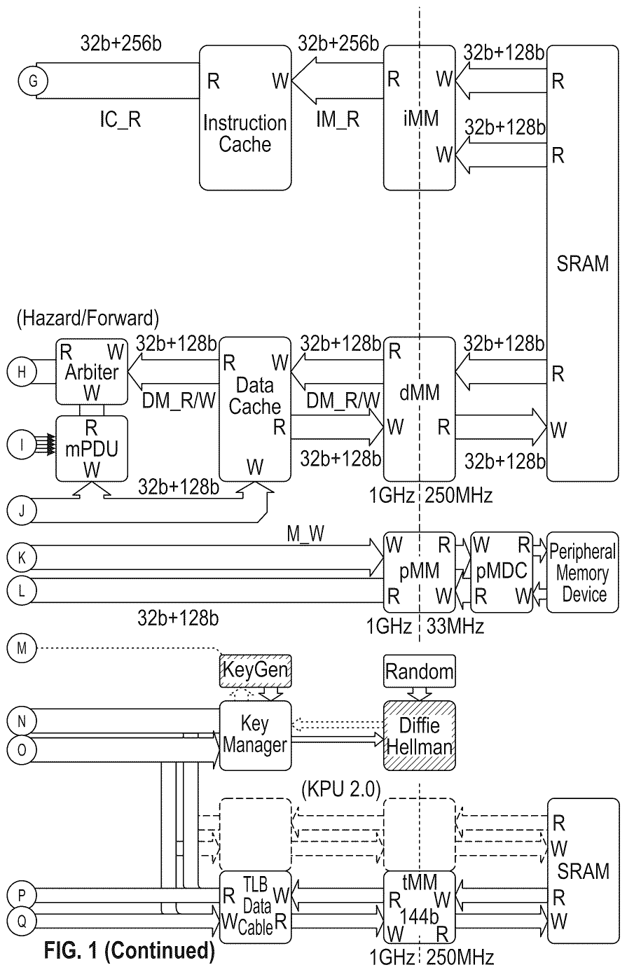

FIG. 1 illustrates a Dynamic Translation Unit (DTU) 101 positioned between the input to the pipeline's fetch stage 103 and the (instruction path) memory management unit (iMMU) 105 in the encrypted processor 107.

The iMMU 105 consists of an instruction address translation lookaside buffer (iTLB) whose job is to remap to physical memory the logical 0,4,8,12, . . . instruction addresses that are required in running programs. The translation is per ‘page’ of memory data, where a page is standardly 8 KB in size. The iTLB in the iMMU caches and manages that page database.

The DTU 101 is intended to fit between pipeline and iMMU in a typical processor core. DTU 101 enables programs in memory that are expressed in one machine code language (here the processor's CISC machine code language) to be seen as being expressed in another machine code language (here the encrypted processor's RISCV machine code language) for the processor pipeline.

It should be appreciated that the data inputs for DTU 101 are binary words representing CISC instructions and its data outputs are binary words representing processor 107 RISCV instructions. DTU 101 is controlled by the processor core pipeline, which requests it for more binary RISCV instruction words, and it in turn emits control requests to the imbue 105 for more binary CISC instruction words from memory.

Programs might be re-engineered from one machine code language to another via software but that cannot be done in the setting of the embodiments because of the security considerations. A re-engineered program might have been modified at some stage by a ‘black hat’ attacker in order to reveal information at runtime that running in the embodiments is intended to keep secure. For example, the attacker might excise the encryption sequences in the program.

### Overall Structure of DTU

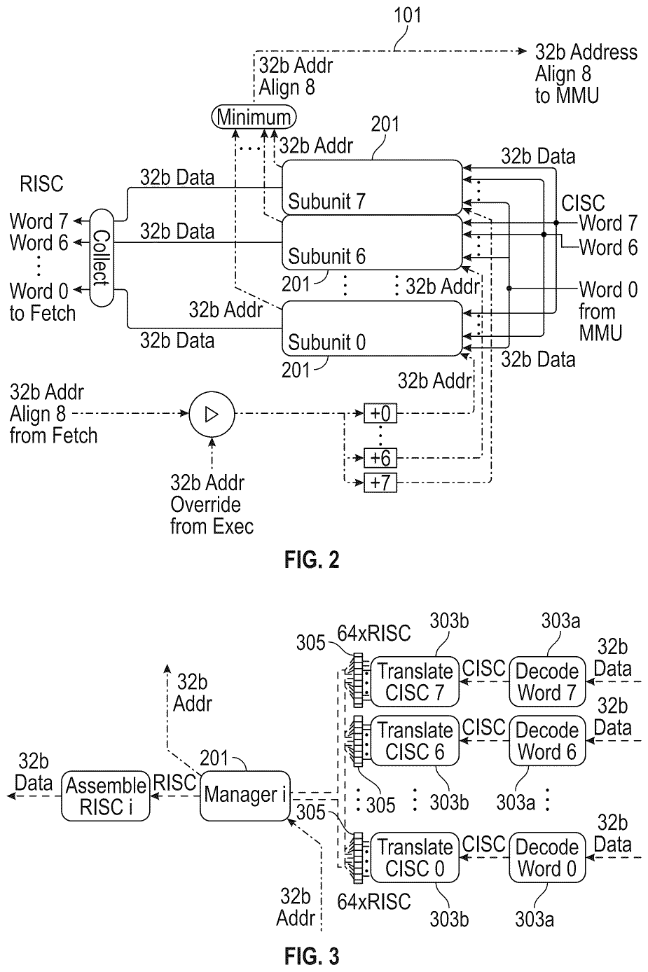

FIG. 2 illustrates further details of the dynamic translation unit in accordance with some embodiments. The DTU 101 consists of (8) repeated subunits 201 in parallel, each translating one of (8) instruction words that the instruction path from the iMMU delivers simultaneously from memory. The number (8) can be varied to match the processor memory path design width. The number (8) is the width (8 words) of the instruction memory path. There are two data ports and two control ports in the DTU 101. Some (8) binary words representing CISC instructions enter the unit at most once per cycle at the input data port on the right of the subunits 201, and (8) binary words representing RISCV instructions leave the subunits 201 at most once per cycle via the data port at the left of the subunits 201.

The individual subunits 201 have four ports, two data ports and two control ports that take 32-bit addresses. On the input control port the address in the virtual address space of the wanted RISCV instruction binary word is asserted, and that instruction appears on the output data port when the subunit has the data required to construct it.

FIG. 3 illustrates further details of a subunit of the DTU in accordance with some embodiments. A vector of (8) CISC instruction words 301 enter on the input data port at right and are decoded 303a and translated 303b to RISCV instructions 305, which are stored in the subunit 201. Also stored are the addresses in memory of the original (8) CISC words and the addresses in the virtual address space of the RISCV instruction words. The calculation of the latter is described below.

Note that the input control port of the subunit 201 receives either a 32-bit virtual address of the next RISCV instruction wanted by the fetch stage of the processor pipeline, or a 32-bit real address in the CISC instruction address space generated by a jump or branch instruction in the exec stage of the processor pipeline. The two kinds are tagged distinctly. In the case of a 32-bit virtual address from the fetch stage, when it is received the subunit 201 always already has data stored. It is not empty of data. That is because before the fetch stage emits a request for a ‘next’ program instruction it has first been set by a jump or branch (a reset is equivalent to a jump to program address 0) to a first program instruction and the handling of that jump/branch address in the subunit results in data being stored internally, described in (2) below. Continuing:
(1a) If the RISCV instruction that the input virtual address points to is among those held in the subunit 201 then it is assembled to a binary 32-bit word and produced on output.
(1b) If the required instruction is not there, then the subunit asks on its control port output for the next vector (of 8) CISC binary words from the iMMU contiguous with that which it stores already. Addresses requested from the fetch stage of the pipeline will increase monotonically absent a jump or branch instruction executing, as in (2) so the required instruction necessarily will be located within the RISCV instruction translated from the next vector of CISC binary words.
(2) Receiving that next vector of (8) binary CISC instruction words and constructing and storing its translation to RISCV instructions, the subunit 201 constructs virtual addresses for them by continuing its count from the last it had before. The treatment is then as in (1a).

In the case of a 32-bit real jump or branch address control port input, the subunit is first reset to empty it of data. This is also the initial configuration at cycle 0.

The subunit 201 puts on its output control port the address in the CISC program address space of the aligned vector (of 8) CISC words that contain the target address. On receipt of that data, decode and translate happens in the subunit 201 and it constructs the virtual addresses of the RISCV instructions so the ith RISCV instruction translated for the CISC instruction at the jump/branch target address minus i words, where this is the ith subunit, gets a virtual address equal to the jump target address. That synchronizes virtual and real address counts at the target address. The RISCV binary instruction word at the target address plus i words is then output on the data port.

It should be appreciated that storage of RISCV translation sequences as described in the paragraphs above duplicates hardware. The worst case has all subunits containing copies of the same data, the data having been created by identical hardware logic applied to the same inputs to each.

In some embodiments storage and decode and translation logic is shared between subunits more efficiently. The only constraint on sharing is that sometimes the subunits necessarily do not all contain the same data. They may between them simultaneously contain data pertinent to 0, 1 or 2 consecutive vectors of (8) CISC instruction binary words. That implies that at most two sets of common storage and decode plus translation logic facilities suffice. The two stores fill independently and autonomously according to the following rules. Vectors of data received are sequences of contiguous binary instruction words and are indexed/identified/tagged by the address of their first element.
(a) if both stores are empty then any next vector of data received is placed in the lower store;
(b) if one of the two stores is full and one is empty then it is always the case that it is the lower that is full and the that is upper empty:
   (b1) if the next vector of data received is contiguous to and following on from that in the lower store then it is placed in the upper store,
   (b2) if the next vector of data received is that already in the lower store then it overwrites the lower store (or is ignored, with the same effect),
   (b3) otherwise the next vector of data received is placed in the lower store and the upper is vacated (this case is associated with a jump or branch instruction execution);
(c) if both stores are full then they contain contiguous vectors of data, and
   (c1) if the next vector of data received is contiguous with and following on from the data in the upper store then the upper store data replaces the data in the lower store (‘push down’) and the new vector of data replaces the data in the upper store,
   (c2) if the next vector of data received as already in either store then it replaces it (or is ignored, with same effect),
   (c3) otherwise the next vector of data received replaces the data in the lower store and the upper store is vacated (this case as with b3 is associated with a branch/jump instruction execution).

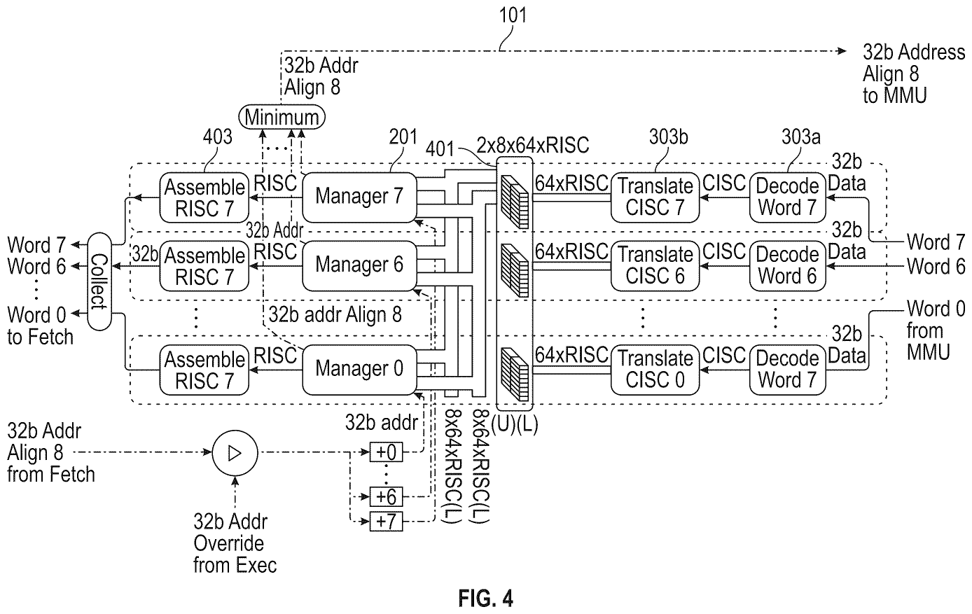

FIG. 4 illustrates a subunit sharing storage in accordance with some embodiments. The (8) translation subunits and (8) decode subunits' outputs lead to shared storage 401 for 2×8×64 RISCV instructions. The ‘2’ reflects the two stores required in the above algorithm, the ‘8’ represents the size in binary instruction words of a single incoming vector of data, the ‘64’ is arbitrary and represents a maximum permitted length of a translation sequence of RISCV instruction words derived from any one incoming binary instruction word. Data is loaded independently and autonomously as described above in paragraph 101, and is accessed by the 8 management subunits 201 which each pick out a single RISCV instruction to pass through a RISCV assembler unit 403, comprising one word of (8) for output.

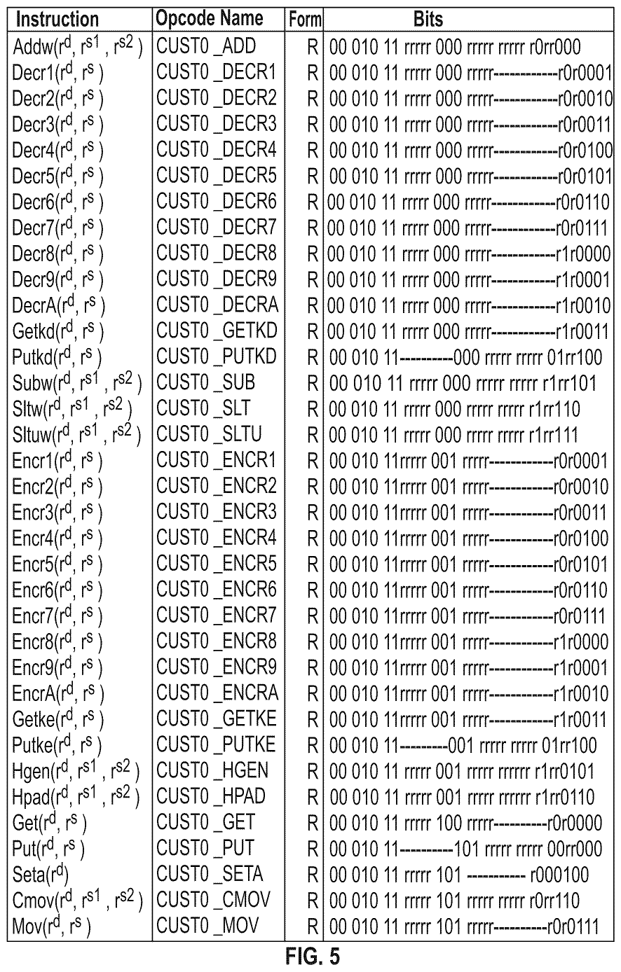

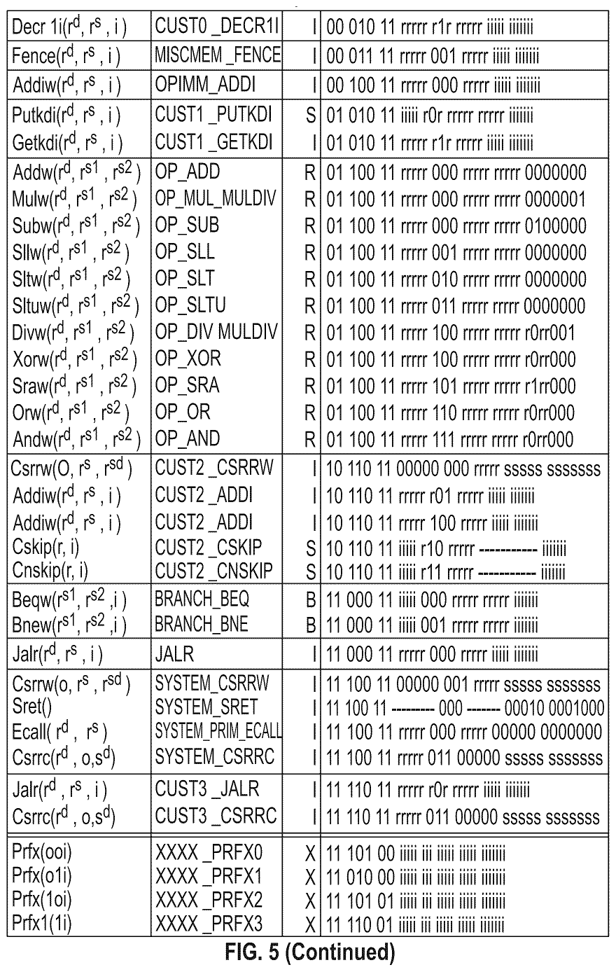

FIG. 5 provides a summary of the processor's RISCV instructions as described in paragraphs 30-60 in accordance with some embodiments. Unrecognized words are converted to no-ops for security. The no-ops can be any instruction that does nothing and has no data dependency, such as mov xer,xer).

In some embodiments, a method is provided. The method includes receiving first binary words associated with a first machine code language instruction set, e.g. CISC. As noted in the Figures above a plurality of subunits of a DTU disposed between a memory unit and a fetch stage of a pipeline of a processing core may receive the first binary words. The method includes. translating the first binary words to second binary words associated with a second machine code language, e.g., RISC, wherein the receiving and the translation are performed within a pipeline of a processor core of a processing device and wherein the first binary word and the second binary word are processed in encrypted format during the receiving and the translating. That is the data that is being processed is never decrypted to provide increased security over existing processing pipelines for processing data. In other words, the data being processed within the pipeline remains encrypted throughout processing within the pipeline. As noted above in FIG. 4, the subunits may share storage resources of the DTU in some embodiments.

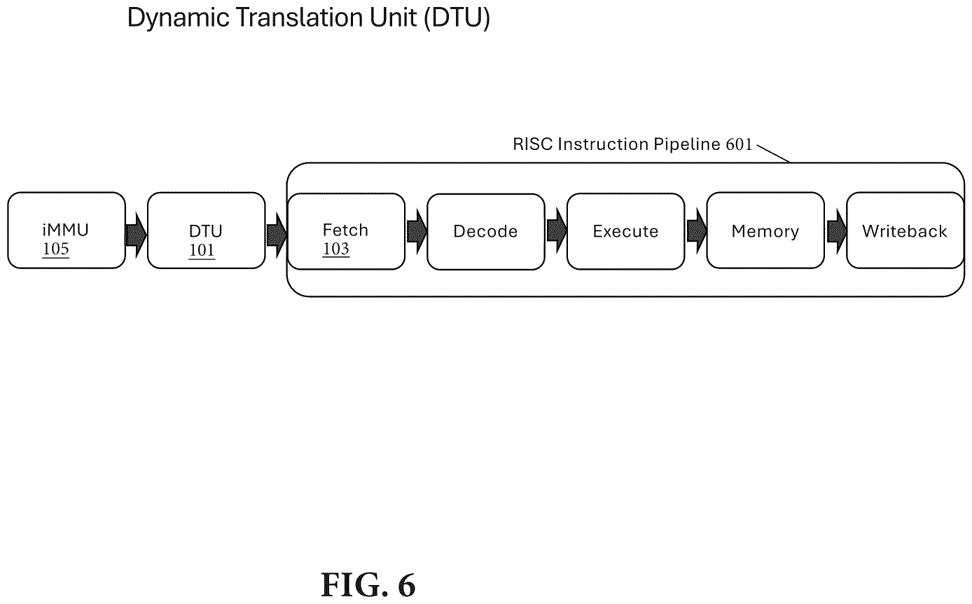

FIG. 6 illustrates an embodiment of a dynamic translation unit (DTU) 101 positioned within an instruction processing pipeline of an encrypted processor. In the embodiment shown, DTU 101 is disposed between an instruction memory management unit (iMMU) 105 and a fetch stage 103 of the RISC instruction pipeline 601.

As illustrated in FIG. 6, the iMMU 105 is configured to perform instruction address translation, including translation of logical instruction addresses to physical memory addresses using an instruction translation lookaside buffer (iTLB). The iMMU 105 provides instruction words retrieved from instruction memory to the DTU 101. The instruction words provided to the DTU 101 may comprise instructions encoded in a first instruction set architecture, such as a Complex Instruction Set Computer (CISC) instruction set.

The DTU 101 is configured to receive instruction words from the iMMU 105 and determine whether the received instruction words require translation. When an instruction word corresponds to an instruction that is directly executable by the downstream pipeline, the DTU 101 forwards the instruction word without modification. When an instruction word corresponds to an instruction requiring translation, the DTU 101 dynamically translates the instruction word into one or more instruction words encoded in a second instruction set architecture, such as a Reduced Instruction Set Computer (RISC) instruction set. The DTU 101 outputs translated instruction words to the fetch stage 103 of the pipeline. The fetch stage 103 receives the instruction words from the DTU 101 and supplies them to subsequent pipeline stages, including decode, execute, memory access, and writeback stages, of RISC instruction pipeline 601 for execution by the processor core.

In the illustrated embodiment of FIG. 6, the DTU 101 operates transparently with respect to the downstream pipeline stages, such that translated instruction words are processed by the fetch and decode stages of RISC instruction pipeline 601 in the same manner as instruction words natively stored in the second instruction set architecture. The placement of the DTU 101 between the iMMU 105 and the fetch stage 103 allows instruction translation to occur after instruction address translation and prior to instruction fetch sequencing within the RISC instruction pipeline 601.

In some embodiments, the DTU 101 operates on instruction words that are encrypted and produces translated instruction words that remain encrypted, such that instruction translation is performed without exposing unencrypted instruction data within the pipeline. In this manner, instruction words remain encrypted throughout instruction retrieval, translation, and pipeline execution. The positioning of the DTU 101 between the iMMU 105 and the fetch stage 103 enables the DTU 101 to be integrated into existing processor architectures with minimal modification to the downstream pipeline logic, while allowing programs stored in memory using a first instruction set architecture to be executed as programs using a second instruction set architecture by the processor core.

In some embodiments, the DTU 101 is positioned logically between the iMMU 105 and the fetch stage 103 of the processor pipeline, as illustrated in FIG. 6. In other embodiments, the DTU 101 may be positioned at different locations along the instruction path, provided that instruction translation occurs prior to execution of translated instructions by the processor core. In some alternative embodiments, the DTU 101 is positioned upstream of the iMMU 105, such that instruction translation occurs prior to instruction address translation. In such embodiments, translated instruction words are subsequently provided to the iMMU 105 for address translation before being fetched by the pipeline.

In some embodiments, the DTU 101 is integrated with the fetch stage 103 of RISC instruction pipeline 601, such that instruction translation and instruction fetch sequencing are performed cooperatively within a combined functional block. In other embodiments, the DTU is implemented as a separate hardware module that interfaces with the fetch stage 103 via one or more instruction buses or control interfaces.

In some embodiments, the DTU 101 is implemented as a standalone hardware unit external to the processor core pipeline, while in other embodiments the DTU 101 is partially or fully integrated within the processor core. For example, translation logic, buffering, or storage resources of the DTU 101 may be shared with decode logic, instruction caches, or pipeline control logic.

In some embodiments, multiple DTUs may be provided, such as one DTU 101 per pipeline, one DTU 101 per processor core, or one DTU 101 shared among multiple processor cores. In other embodiments, the DTU 101 may be selectively enabled or bypassed on a per-instruction, per-thread, or per-process basis. As described above, instruction words processed by the DTU 101 remain encrypted throughout translation and subsequent pipeline processing. In other embodiments, instruction words may be partially decrypted, re-encrypted, or transformed using different encryption domains, provided that plaintext instruction semantics are not exposed to observers outside a trusted execution boundary.

1. A processor, comprising:
a pipeline comprising a plurality of processing stages including a fetch stage;
an instruction memory management unit (IMMU) configured to translate instruction addresses for accessing instruction memory;
a dynamic translation unit (DTU) disposed between the iMMU and the fetch stage; and
a plurality of encrypted processing stages arranged within the pipeline, wherein the DTU is configured to receive instruction words from the iMMU and selectively translate at least some of the instruction words before providing instruction words to the fetch stage, and wherein encrypted data processed by the plurality of encrypted processing stages remains encrypted throughout propagation through the pipeline.

2. The processor of claim 1, wherein encrypted output data of a first encrypted processing stage is provided as encrypted input data to a second encrypted processing stage without decryption.

3. The processor of claim 1, wherein each encrypted processing stage applies a respective encrypted transformation to encrypted input data.

4. The processor of claim 1, wherein an aggregate effect of encrypted transformations applied by the plurality of encrypted processing stages is equivalent to performing a sequence of data processing operations on corresponding decrypted data and encrypting a result of the sequence.

5. The processor of claim 1, wherein the DTU is positioned on an instruction path such that instruction address translation by the iMMU occurs prior to instruction translation by the DTU.

6. The processor of claim 1, wherein the DTU is configured to pass through instruction words unmodified when translation is not required.

7. The processor of claim 1, wherein the DTU is configured to translate instruction words encoded in a first instruction set architecture into instruction words encoded in a second instruction set architecture.

8. The processor of claim 7, wherein the first instruction set architecture comprises a Complex Instruction Set Computer (CISC) instruction set and the second instruction set architecture comprises a Reduced Instruction Set Computer (RISC) instruction set.

9. The processor of claim 1, wherein instruction words provided to the DTU and instruction words output from the DTU remain encrypted.

10. The processor of claim 1, wherein the DTU operates transparently with respect to downstream pipeline stages such that translated instruction words are processed by the fetch stage in the same manner as non-translated instruction words.

11. A method of processing encrypted data and instructions in a processor pipeline, comprising:
translating instruction addresses using an instruction memory management unit (iMMU);
providing instruction words from the iMMU to a dynamic translation unit (DTU) disposed between the iMMU and a fetch stage of the processor pipeline;
selectively translating, by the DTU, at least some of the instruction words;
fetching instruction words output from the DTU into the pipeline; and
processing encrypted data through a plurality of encrypted processing stages of the pipeline, wherein the encrypted data remains encrypted throughout processing by the pipeline.

12. The method of claim 11, wherein encrypted intermediate data generated by a first encrypted processing stage is propagated to a second encrypted processing stage without decryption.

13. The method of claim 11, wherein selectively translating comprises translating instruction words from a first instruction set architecture to a second instruction set architecture.

14. The method of claim 11, further comprising passing instruction words through the DTU without modification when translation is not required.

15. The method of claim 11, wherein instruction words remain encrypted during instruction address translation, instruction translation, and instruction fetch.

16. The method of claim 11, wherein an aggregate effect of encrypted processing by the plurality of encrypted processing stages is equivalent to execution of a plaintext instruction sequence followed by encryption of a result.

17. A non-transitory computer-readable medium storing instructions that, when executed by a processor, cause the processor to:
translate instruction addresses using an instruction memory management unit (iMMU);
route instruction words from the iMMU to a dynamic translation unit (DTU) disposed between the iMMU and a fetch stage of a processor pipeline;
selectively translate at least some of the instruction words using the DTU;
fetch instruction words output from the DTU into the pipeline; and
process encrypted data through a plurality of encrypted processing stages of the pipeline such that the encrypted data remains encrypted throughout processing.

18. The computer-readable medium of claim 17, wherein the instructions cause the DTU to translate instruction words from a CISC instruction set to a RISC instruction set.

19. The computer-readable medium of claim 17, wherein the instructions cause encrypted intermediate data to be propagated between encrypted processing stages without decryption.

20. The computer-readable medium of claim 17, wherein the instructions cause the DTU to operate independently of decode and execution stages of the processor pipeline.
